(19) United States
(12) Patent Application Publication
(10) Pub. No.: US 2023/0106428 A1
(43) Pub. Date: Apr. 6, 2023

(54) SWITCH SYSTEMS FOR RECHARGEABLE BATTERY ARRAYS

(71) Applicant: SPARKION POWER ALGORITHMS LTD, Herzliya (IL)

(72) Inventors: Shmuel BEN YAAKOV, Tel Yitzhak (IL); Tomer BENTZION, Tel Aviv (IL)

(21) Appl. No.: 17/910,163

(22) PCT Filed: Mar. 8, 2021
(86) PCT No.: PCT/IL2021/050254

§ 371 Date: Sep. 8, 2022

Related U.S. Application Data
(60) Provisional application No. 62/986,865, filed on Mar. 9, 2020.

(51) Int. Cl. H02J 7/00; H01M 10/44; H01M 10/42; H01M 10/48; B60L 50/60; B60L 58/12

(52) U.S. Cl. CPC H02J 7/0024; H02J 7/0025; H01M 10/441; H01M 10/425; H01M 10/482; B60L 50/60; B60L 58/12; H01M 2010/4271

(57) ABSTRACT

Disclosed herein is a switch system for rechargeable power storage devices (PSDs). The switch system includes a controller and a first and second switching modules. The first switching module is serially-connected to a PSD. The second switching module is connected in parallel to the PSD and the first switching module. Each switching module is switchable by the controller between: a state S₁, wherein current cannot flow (through the switching module) in a first direction; a state S₂, wherein current flow cannot flow opposite to the first direction; a state S₃, wherein current may flow in both directions; and a state S₀, wherein current cannot flow in any direction. The switch system is configured to preclude joint states (S₁, S₂), (S₁, S₃), (S₃, S₂), (S₃, S₃), with the first and second entries denoting states of the first and second switching modules, respectively, thereby preventing possibility of short-circuit.

### TECHNICAL FIELD

The present disclosure relates generally to systems and methods for electrochemical energy storage management.

### BACKGROUND

Since a battery pack's performance is limited by the “weakest” (electrochemical) cell, once the weakest cell is depleted, the entire stack is effectively depleted. Even for battery packs consisting of cells fabricated to the same specification (i.e. same chemistry and dimensions), the above-mentioned fact constitutes a severe limitation on performance. Crucially, cells fabricated to the same specification may differ from one another in their capacities, internal resistances, and self-discharge rates. Moreover, cells fabricated to the same specification may age differently, which adds an additional uncertainty factor to a battery pack's life equation.

With a looming transition to alternative energies from fossil fuels, the need for methods and systems, which will optimize the performance of battery packs and extend their life-times, grows ever more relevant.

### SUMMARY

Aspects of the disclosure, according to some embodiments thereof, relate to systems and methods for electrochemical energy storage management. More specifically, but not exclusively, aspects of the disclosure, according to some embodiments thereof, relate to switch systems and methods for rechargeable power storage devices (PSDs).

The present application discloses systems and methods for managing an array of PSDs (e.g. electrochemical cells, battery modules, battery packs)—which overcome the limitations of the weakest PSDs (e.g. the cells with the lowest capacities or highest resistances, or a combination of capacity and resistance that renders them “weakest”) in the array. This is achieved via an infrastructure that is capable of reconfiguring such that the weakest PSDs may be “sidelined” and, if necessary, compensated for. Key to this is the possibility of safely enabling and circumventing each PSD while avoiding, or at least minimizing, risk of short-circuit, and maintaining a fixed, or substantially fixed, current throughout the transition from an enabled state to a disabled state (in the sense that the PSD is circumvented) and vice-versa (so that potentially damaging dips in the current are avoided). Advantageously, the present application discloses such a switch system (i.e. with the above-listed features). The switch system includes pairs of switching modules, wherein each pair may be associated with a respective PSD and a controller.

In addition to switch system, each array may further include monitoring equipment, and one or more DC-DC chargers, associated with the controller. The controller may be configured to identify when a weak PSD is close to being depleted (when discharging) or close to being saturated (i.e. fully charged, when charging), based on data received thereby from the monitoring equipment, and accordingly instruct the respective pair of switching modules circumvent the PSD. Consequently, balancing of PSDs is rendered unnecessary, since, if required, the PSD may promptly be circumvented. As a further advantage, the option of circumventing PSDs (combined with monitoring thereof) may be utilized to prevent occurrence of over-voltage and under-voltage states without disabling other PSDs or otherwise disrupting the operation thereof.

Each of the DC-DC chargers may have a dynamic and reactive input voltage, based on the number, respective output voltages, and the configuration of the enabled PSDs connected thereto. Advantageously, this allows charging and/or powering different DC loads, and, in particular, rechargeable (DC) loads, which may differ significantly from one another in their input voltages. (AC loads may also be charged and/or charged, using suitable DC-to-AC circuitry.)

More generally, the infrastructure may be reconfigurable also in terms of allowing to controllably change the type of coupling between groups of PSDs (or even individual PSDs), for example, from connection in series to connection in parallel. The controller may be configured to optimize over the possible configurations of the array (by disabling some PSDs, enabling other PSDs, and, optionally, changing the couplings between PSDs), such as to optimally meet charge and/or discharge requirements. The flexibility offered by the above-described reconfigurability renders the disclosed systems and methods accommodating of different PSDs, which may differ significantly from one another, not least in their output voltages. Advantageously, the disclosed systems and methods allow for repurposing of discarded rechargeable batteries, pertinently, retired electric vehicle (EV) batteries.

Thus, according to an aspect of some embodiments, there is provided a switch system for one or more rechargeable power storage devices (PSDs). The switch system includes a controller and pair of switching modules. The switching modules include a first switching module and a second switching module, which are functionally associated with the controller. The first switching module is serially-connected to the PSD and is positioned together therewith (i.e. with the PSD) on a first line. The first line extends from a first junction A to a second junction B with a positive polarity of the PSD pointing in the A-to-B direction (i.e. from the first junction A to the second junction B). The second switching module is connected in parallel to the PSD and the first switching module and is positioned on a second line extending from A (i.e. the first junction) to B (the second junction). Each of the first switching module and the second switching module is switchable by the controller between four module states:
a module state S₁, wherein current flow therethrough from B to A is blocked;
a module state S₂, wherein current flow therethrough from A to B is blocked;
a module state S₃, wherein current is capable of flowing therethrough both from A to B and B to A; and
a module state S₀, wherein current flow therethrough in both directions is blocked.

The switch system is configured to preclude joint states (S₁, S₂), (S₁, S₃), (S₃, S₂), and (S₃, S₃). A first entry in each pair of brackets denotes a module state of the first switching module. The second entry in each pair of brackets denotes a module state of the second switching modules. The preclusion of the joint states (S₁, S₂), (S₁, S₃), (S₃, S₂), and (S₃, S₃) prevents possibility of short-circuit via discharge of the PSD onto itself.

According to some embodiments, the controller is further configured to:
disable the PSD, when discharging, by diverting current from the first line to the second line via switching of the switching modules from (S₃, S₀) to (S₀, S₃), via (S₁, S₁) and/or (S₃, S₁); and
enable the PSD to discharge, by diverting current from the second line to the first line via switching of the switching modules from (S₀, S₃) to (S₃, S₀), via (S₁, S₁) and/or (S₃, S₁).

According to some embodiments, the controller is further configured to:
disable the PSD, when charging, by diverting current from the first line to the second line via switching of the switching modules from (S₃, S₀) to (S₀, S₃), via (S₂, S₂) and/or (S₂, S₃); and
enable the PSD to charge, by diverting current from the second line to the first line via switching of the switching modules from (S₀, S₃) to (S₃, S₀), via (S₂, S₂) and/or (S₂, S₃).

According to some embodiments, the first switching module includes two serially-connected switching units: a first switching unit and a second switching unit. The second switching module includes two serially-connected switching units: a third switching unit and a fourth switching unit. Each of the first and third switching units is switchable between a two-way conduction state M, wherein current is capable of flowing through the switching unit both in A-to-B direction and the B-to-A (one direction at a time), and a first one-way conduction state M_{AB}, wherein current flow therethrough from B to A is blocked. Each of the second and fourth switching units is switchable between a two-way conduction state M, wherein current is capable of flowing through the switching unit both in A-to-B direction and the B-to-A (one direction at a time), and a second one-way conduction state M_{BA}, wherein current flow therethrough from A to B is blocked.

According to some embodiments, when the first switching module is in the module state S₀, the first and second switching units are in the states M_{AB} and M_{BA}, respectively. When the first switching module is in the module state S₁, the first and second switching units are in the states M_{AB} and M, respectively. When the first switching module is in the module state S₂, the first and second switching units are in the states M and M_{BA}, respectively. When the first switching module is in the module state S₃, the first and second switching units are each in the state M. When the second switching module is in the module state S₀ the third and fourth switching units are in the states M_{AB} and M_{BA}, respectively. When the second switching module is in the module state S₁, the third and fourth switching units are in the states M_{AB} and M, respectively. When the second switching module is in the module state S₂, the third and fourth switching units are in the states M and M_{BA}, respectively. When the second switching module is in the module state S₃, the third and fourth switching units are each in the state M.

According to some embodiments, in one or both of the switching modules, each of the switching units includes a respective transistor. Each of the transistors includes a respective input terminal, output terminal, and control terminal. The control terminal is communicatively associated with the controller. Each of the switching units additionally includes a respective diode mounted between the input terminal and the output terminal of the respective transistor, as to be connected in parallel to the transistor, unless the diode is a body diode, in which case the diode is included in the transistor.

According to some embodiments, a first terminal of the first switching unit is connected to a first terminal of the second switching unit. The first terminal and a second terminal of the first switching unit are the input and output terminals, respectively, or the output and input terminals, respectively, of the first switching unit. The first terminal and a second terminal of the second switching unit are the input and output terminals, respectively, or the output and input terminals, respectively, of the second switching unit. The respective diode of each of the first and second switching units is configured to block flow of current through the diode from the first terminal to the second terminal of the switching unit.

According to some embodiments, a first terminal of the third switching unit is connected to a first terminal of the fourth switching unit. The first terminal and a second terminal of the third switching unit are the input and output terminals, respectively, or the output and input terminals, respectively, of the third switching unit. The first terminal and a second terminal of the fourth switching unit are the input and output terminals, respectively, or the output and input terminals, respectively, of the fourth switching unit. The respective diode of each of the third and fourth switching units is configured to block flow of current through the diode from the first terminal to the second terminal of the switching unit.

According to some embodiments, one or more the transistors is a field-effect transistor (FET), with the input terminal thereof corresponding to the source of the FET, the output terminal thereof corresponding to the drain of the FET, and the control terminal thereof corresponding to the gate of the FET.

According to some embodiments, one or more of the transistors is a bipolar transistor, with the input terminal thereof corresponding to the collector of the bipolar transistor, the output terminal thereof corresponding to the emitter of the bipolar transistor, and the control terminal thereof corresponding to the base of the bipolar transistor.

According to some embodiments, the FET is a metal-oxide semiconductor FET (MOSFET).

According to some embodiments, wherein, in at least some of the switching modules, whose switching units are or include a respective pair of serially-connected MOSFETs, a source of a first MOSFET from the pair is connected to a source of a second MOSFET from the pair, or a drain of the first MOSFET from the pair is connected to a drain of the second MOSFET from the pair.

According to some embodiments, each of the switching units includes a plurality of transistors connected in parallel to one another, such that input terminals of the transistors in each switching unit are connected (i.e. joined) and the output terminals of the transistors in each switching unit are connected (i.e. joined).

According to some embodiments, in switching from a start state to an end state, a duration spent in an intermediate state is at least about a time it takes for the switching modules to switch between module states. The intermediate state is switched to between the start state and the end state. In the intermediate state that current is capable of flowing through both the first line and the second line. In diverting current from the first line to the second line, when the PSD is charging or discharging, the start state is (S₃, S₀) and the end state is (S₀, S₃). In diverting current from the second line to the first line, so as to charge or discharge the PSD, the start state is (S₀, S₃) and the end state is (S₃, S₀).

According to some embodiments, the switch system further includes a first interlock and a second interlock, which are functionally associated with the controller. The first switching unit is coupled to the fourth switching unit via the first interlock. The first interlock is configured to prevent any module state wherein the first switching unit is in any of the states M and M_{AB} and the fourth switching unit is simultaneously in any of the states M and M_{BA}. The second switching unit is coupled to the third switching unit via the second interlock. The second interlock is configured to prevent any module state wherein the second switching unit is in any of the states M and M_{BA} and the third switching unit is simultaneously in any of the states M and M.

According to some embodiments, the switch system further includes a first interlock and a second interlock, which are functionally associated with the controller. The first interlock is coupled to the controller inputs of the transistor of the first switching unit and the transistor of the fourth switching unit, so as to prevent any module state wherein the first switching unit is in any of the states M and M_{AB} and the fourth switching unit is simultaneously in any of the states M and M_{BA}. The second interlock is coupled to the controller inputs of the transistor of the second switching unit and the transistor of the third switching unit, so as to prevent any module state wherein the second switching unit is in any of the states M and M_{BA} and the first switching unit is simultaneously in any of the states M and M.

According to some embodiments, the PSD includes a rechargeable battery pack.

According to some embodiments, the battery pack includes a plurality of batteries connected, or connectable, to one another in series, parallel, and/or a combination thereof.

According to some embodiments, the battery pack is an electric vehicle (EV) battery pack.

According to some embodiments, the EV battery pack is a second-life EV battery pack.

According to some embodiments, wherein the PSD includes a supercapacitor.

According to some embodiments, the switch system further includes monitoring equipment. The monitoring equipment may include one or more of an ammeter, a voltmeter, an ohmmeter, and/or capacitance meter. The monitoring equipment is configured to monitor a state-of-charge (SoC) and/or remaining capacity, of the PSD, and to send to the monitored SoC and/or the monitored remaining capacity, to the controller. The controller is configured to, when the PSD is discharging, instruct the switching modules to disable the PSD when the PSD becomes depleted or sufficiently near depleted.

The controller is configured to, when the PSD is charging, instruct the switching modules to disable the PSD when the PSD becomes saturated or sufficiently near saturated.

According to some embodiments, the monitoring equipment further includes one or more of a thermometer, configured to measure a temperature of the PSD, and/or a pressure meter, configured to measure a pressure within the PSD. The monitoring equipment is configured to send the measured temperature and/or the measured pressure to the controller. The controller is configured to instruct the switching modules to disable the PSD when the measured temperature exceeds a threshold temperature and/or when the measured pressure exceeds a threshold pressure.

According to some embodiments, the switch system further includes the PSD.

According to some embodiments, the switch system includes a plurality of the pairs of switching modules. Each pair of switching modules is configured to allow enabling and disabling a respective PSD.

According to an aspect of some embodiments, there is provided a method for switching current between a first line and a second line. The first line has mounted thereon a power storage device (PSD). The two lines extend from a first junction to a second junction. The method includes, starting at an initial circuit state, wherein current is capable of being conducted through a first of the two lines in both directions, and is presently conducted in a first direction, and current flow through a second of the two lines is blocked, performing operations of:
precluding current flow through the first line in opposite to the first direction;
enabling current flow through the second line in the first direction, so that the current is divided between the two lines, flowing in the first direction through each of the two lines; and
blocking current flow through the first line and enabling possibility of current flow through the second line in both directions, so that the current flows only through the second line and in the first direction.

According to some embodiments, the method is implemented using the above-described switch system.

According to an aspect of some embodiments, there is provided a power management system (PMS) for controlling and regulating charging and discharging of an array including rechargeable PSDs. The PMS includes the above-described switch system, and monitoring equipment configured to monitor at least SoCs and/or remaining capacities of the PSDs in the array. The controller is configured to switch each of the switching modules between the respective module states thereof based at least on the monitored SoCs and/or remaining capacities of the PSDs in the array.

According to some embodiments, the monitoring equipment is further configured to monitor, at least periodically, charge capacities of the PSDs in the array. The controller is configured to switch each of the switching modules between the respective module states thereof based also on the monitored charge capacities of the PSDs in the array.

According to some embodiments, the PMS is connectable to a power grid, and configured to allow selectively charging each of the PSDs in the array from the power grid.

According to some embodiments, the controller is configured to allow charging a first group of PSDs in the array while simultaneously discharging a second group of PSDs in the array.

According to some embodiments, the PMS further includes infrastructure whereon the PSDs in the array are installed or installable.

According to some embodiments, the infrastructure is modular so as to allow adding one or more additional PSDs to the array.

According to some embodiments, the PMS is configured to allow replacing one or more of the PSDs in the array while one or more of the other PSDs in the array are charging and/or discharging.

According to some embodiments, the PSDs in the array include a plurality of battery packs of EVs.

According to some embodiments, the battery packs of EVs include battery packs of one or more of electric passenger cars, vans, trucks, and/or motorcycles.

According to some embodiments, the PMS further includes a DC-DC charger connectable to the array, so as to allow charging rechargeable loads over a range of voltages.

According to some embodiments, the DC-DC charger is bidirectional, so as to allow discharging a rechargeable load onto one or more PSDs in the array.

According to some embodiments, the PMS further includes one or more additional DC-DC chargers, so as to allow simultaneously charging a plurality of rechargeable loads characterized by different charging voltages.

According to some embodiments, the controller is configured to determine, based on charge requirements of one or more rechargeable loads, which of the PSDs is or are to be employed to charge the one or more rechargeable loads, such that one or more of a power consumption, charging time, and electricity cost is minimized, or substantially minimized (e.g. to within 5%, 10%, or 20% above the actual minimum), and/or a desired trade-off there between is achieved.

According to some embodiments, the rechargeable loads include battery packs of EVs.

According to some embodiments, the rechargeable loads include battery packs of electric passenger cars, vans, trucks, and/or motorcycles.

According to some embodiments, the rechargeable loads include battery packs of electric mobile industrial machinery.

According to an aspect of some embodiments, there is provided a switch system for one or more rechargeable power storage devices (PSDs). The switch system includes a controller and pair of switching modules including a first switching module and a second switching module, which are functionally associated with the controller. The first switching module is serially-connected to the PSD and is positioned together therewith on a first line extending from a first junction A to a second junction B with a positive polarity of the PSD pointing in the A-to-B direction. The second switching module is connected in parallel to the PSD and the first switching module and is positioned on a second line extending from A to B.

The first switching module is switchable by the controller between at least two module states:
a first module state Uₒₙ, wherein current is capable of flowing therethrough both from A to B and B to A; and
a first module state U_{off}, wherein current flow therethrough in both directions is blocked.

The second switching module is switchable by the controller between four first module states:
a second module state S₁, wherein current flow therethrough from B to A is blocked;
a second module state S₂, wherein current flow therethrough from A to B is blocked;
a second module state S₃, wherein current is capable of flowing therethrough both from A to B and B to A; and
a second module state S₀, wherein current flow therethrough in both directions is blocked.

The switch system is configured to preclude joint states (Uₒₙ, S₂) and (Uₒₙ, S₃), with a first and a second entry in each pair of brackets denoting module states of the first and second switching modules, respectively, thereby preventing a possibility of short-circuit via discharge of the PSD onto itself.

According to some embodiments, wherein the controller is further configured to:
to divert current from the first line to the second line, when the PSD is discharging, by switching the switching modules from (Uₒₙ, S₀) to (U_{off}, S₁), via (Uₒₙ, S₁); and
to divert current from the second line to the first line, so as to discharge the PSD, by switching the switching modules from (U_{off}, S₃) to (Uₒₙ, S₀), via (Uₒₙ, S₁).

According to an aspect of some embodiments, there is provided a switch system for one or more rechargeable power storage devices (PSDs). The switch system includes a controller and a first switching module and second a switching module, which are functionally associated with the controller. The first switching module is serially-connected to the PSD and is positioned together therewith on a first line extending from a first junction A to a second junction B with a positive polarity of the PSD pointing in the A-to-B direction. The second switching module is connected in parallel to the PSD and the first switching module and is positioned on a second line extending from A to B.

Each switching module is switchable by the controller between three module states:
a module state S₁, wherein current flow therethrough from B to A is blocked;
a module state S₂, wherein current flow therethrough from A to B is blocked; and
a module state S₀, wherein current flow therethrough in both directions is blocked.

The switch system is configured to preclude a joint state (S₁, S₂)—with a first entry in each pair of brackets denoting a module state of the first switching module a second entry in each pair of brackets denoting a module state of the second switching module—thereby preventing a possibility of short-circuit via discharge of the PSD onto itself.

According to some embodiments, wherein the controller is further configured to:
to divert current from the first line to the second line, when the PSD is discharging, by switching the switching modules from (S₁, S₀) to (S₀, S₁), via (S₁, S₁); and
to divert current from the second line to the first line, so as to discharge the PSD, by switching the switching modules from (S₀, S₁) to (S₁, S₀), via (S₁, S₁).

According to some embodiments, wherein the controller is further configured to:
to divert current from the first line to the second line, when the PSD is charging, by switching the switching modules from (S₂, S₀) to (S₀, S₂), via (S₂, S₂); and
to divert current from the second line to the first line, so as to charge the PSD, by switching the switching modules from (S₀, S₂) to (S₂, S₀), via (S₂, S₂).

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1A is a combined block-circuit diagram of a switch system for a rechargeable power storage device (PSD), the switch system including a controller and a pair of switching modules, according to some embodiments;

FIGS. 1B to 1D are circuit diagrams depicting switching of the switch system of FIG. 1A from an initial state wherein the PSD is discharging to a final state wherein the PSD is bypassed, according to some embodiments;

FIGS. 1E to 1G are circuit diagrams depicting switching of the switch system of FIG. 1A from an initial state wherein the PSD is charging to a final state wherein the PSD is bypassed, according to some embodiments;

FIG. 2 is a combined block-circuit diagram of a specific embodiment of the switch system of FIG. 1A, wherein each of the switching modules include a pair of serially-connected switching units;

FIG. 3A is a circuit diagram depicting the switching units of FIG. 2, according to specific embodiments thereof, wherein each of the switching units include a switch component and a diode;

FIGS. 3B to 3E depict successive stages in switching of the switching units of FIG. 3A from an initial state wherein the PSD is discharging to a final state wherein the PSD is bypassed, according to some embodiments;

FIGS. 3F to 3I depict successive stages in switching of the switching units of FIG. 3A from an initial state wherein the PSD is bypassed to a final state wherein the PSD is charging, according to some embodiments;

FIG. 4A is a specific embodiment of the circuit diagram of FIG. 3A, wherein each of the switch components is a metal-oxide semiconductor field-effect transistor (MOSFET);

FIG. 4B is a specific embodiment of the circuit diagram of FIG. 3A, wherein each of the switch components includes a plurality of MOSFETs, which are coupled in parallel;

FIG. 5 is a flowchart of a method for bypassing/enabling a rechargeable PSD, according to some embodiments;

FIG. 6 is a block diagram of an energy storage including a PSD array of rechargeable PSDs and a power management system (PMS) configured to control and regulate charging and discharging of the PSDs in the array via a switching assembly including a plurality of the pair of switching module of FIG. 1, according to some embodiments;

FIG. 7A presents a circuit diagram relating PSDs in the PSD array, the pairs of switching modules of the switching assembly, additional switches, and DC-DC chargers of the energy storage of FIG. 6, according to some embodiments;

FIGS. 7B to 7J respectively illustrate example wiring configurations of PSDs realizable by the PMS of FIG. 7A, according to some embodiments;

FIGS. 8A to 9 present experimental results obtained using a prototype, which is a specific embodiment of the PMS of FIG. 6, the results demonstrate the advantages afforded by the disclosed switch systems and switch methods, according to some embodiments; and

FIG. 10 is a combined block-circuit diagram of a switch system for a rechargeable power storage device (PSD), the switch system including a controller and a pair of switching modules, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

Referring to the figures, optional elements/components may appear within boxes delineated by a dashed line. In flowcharts, operations on a system are represented by sharped cornered rectangles, while states of the system (whether initial, intermediate, or final states) are represented by rounded cornered rectangles.

As used herein, the verb “to circumvent” is used in the meaning of “to bypass”. Accordingly, the verbs “to circumvent” and “to bypass” are used interchangeably, as are derivatives thereof

Switch Systems

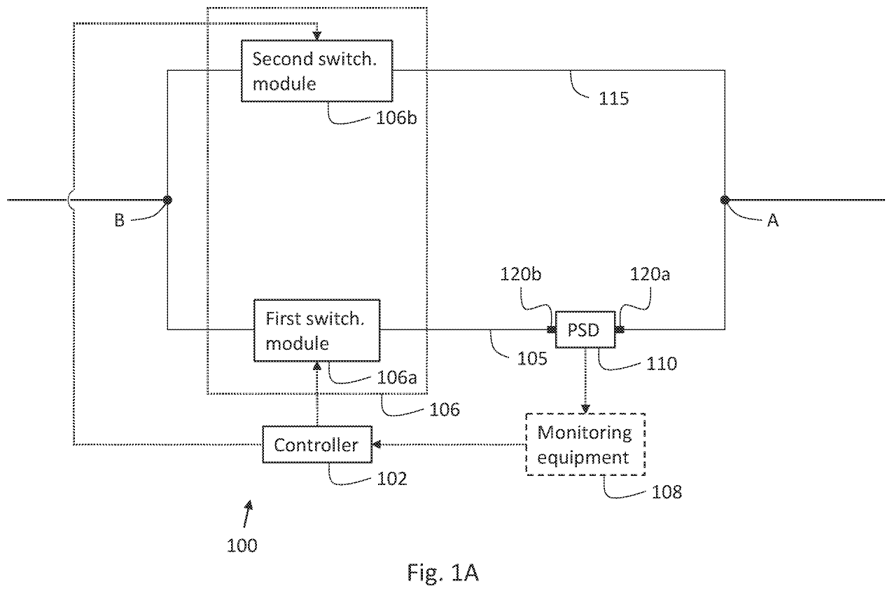

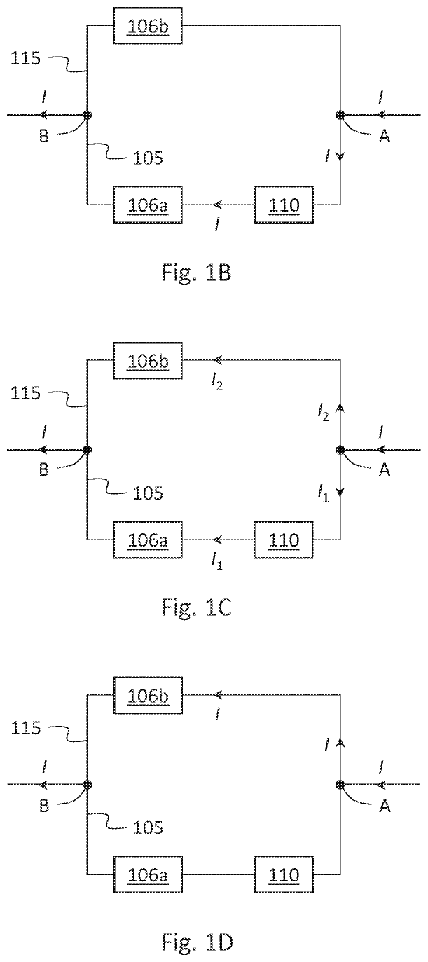

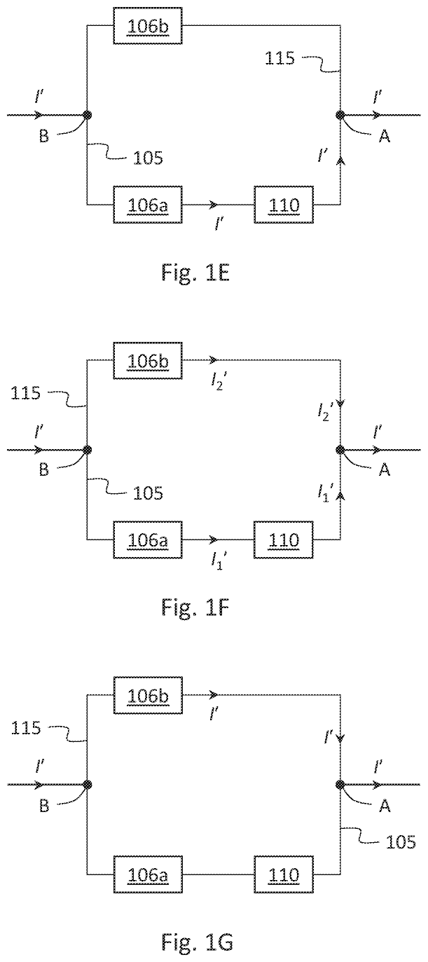

FIG. 1A is a combined block-circuit diagram of a switch system 100 for one or more rechargeable power storage devices (PSDs), according to some embodiments. Switch system 100 includes a controller 102 and a pair of switching modules 106, which is functionally associated with controller 102. Switching modules 106 include a first switching module 106a and a second switching module 106b. According to some embodiments, switch system 100 may further include monitoring equipment 108, which is functionally associated with controller 102.

Also shown in FIG. 1A is a rechargeable PSD 110. PSD 110 is an electrochemical energy storage device, which is rechargeable. According to some embodiments, PSD 110 may be an electrochemical cell (such as a lithium ion battery), a battery module, a battery pack, or a supercapacitor, as further detailed below.

Typically, an electrochemical cell includes an anode(s) and a cathode(s) with current collectors affixed thereto. The electrochemical cell includes a soft or hard package (e.g. a pouch, a prismatic or cylindrical package). As used herein, according to some embodiments, the terms “electrochemical cell” and “battery” may be used interchangeably. As used herein, a “battery module” may include a plurality of electrochemical cells. A “battery pack” may include one or more battery modules.

Rechargeable electrochemical energy storage devices, such as batteries and supercapacitors, come in a large variety of shapes and forms (cylindrical, prismatic, pouch, etc.) and types (chemistries). Examples of chemistries include lithium cobalt oxide (LiCoO₂), lithium iron phosphate (LFP), lithium manganese oxide (LMO), lithium nickel manganese cobalt oxide (NMC), lithium nickel cobalt aluminum oxide (NCA), and lithium titanate oxide (LTO). Other common rechargeable cell chemistries include lead acid, nickel-cadmium (NiCad), and nickel metal hydride (NiMH).

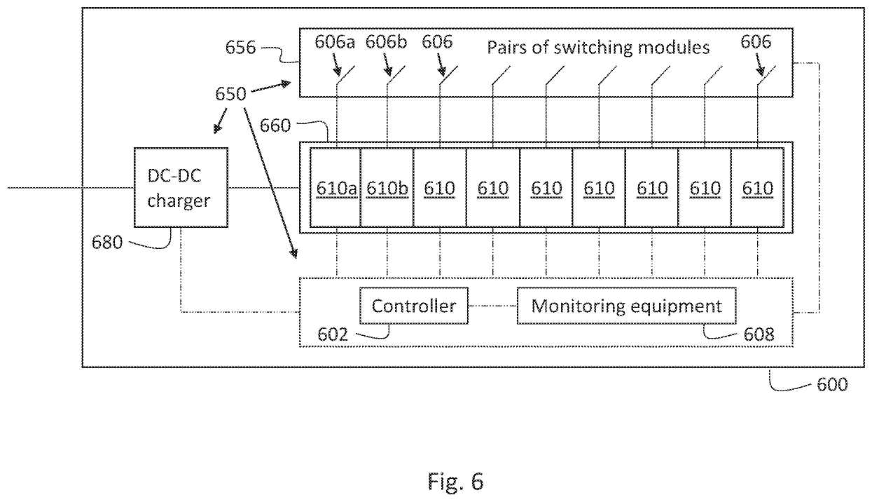

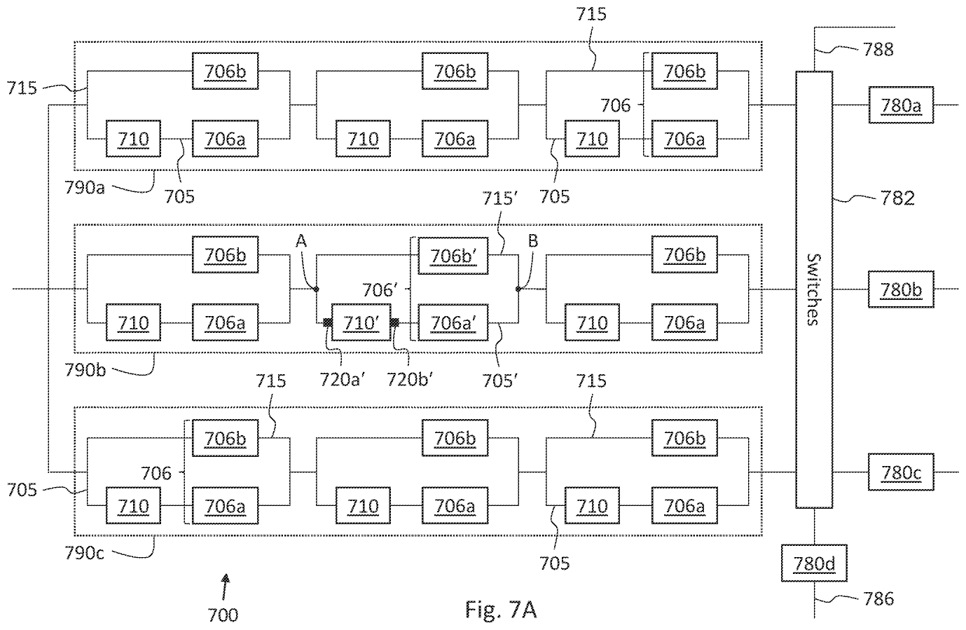

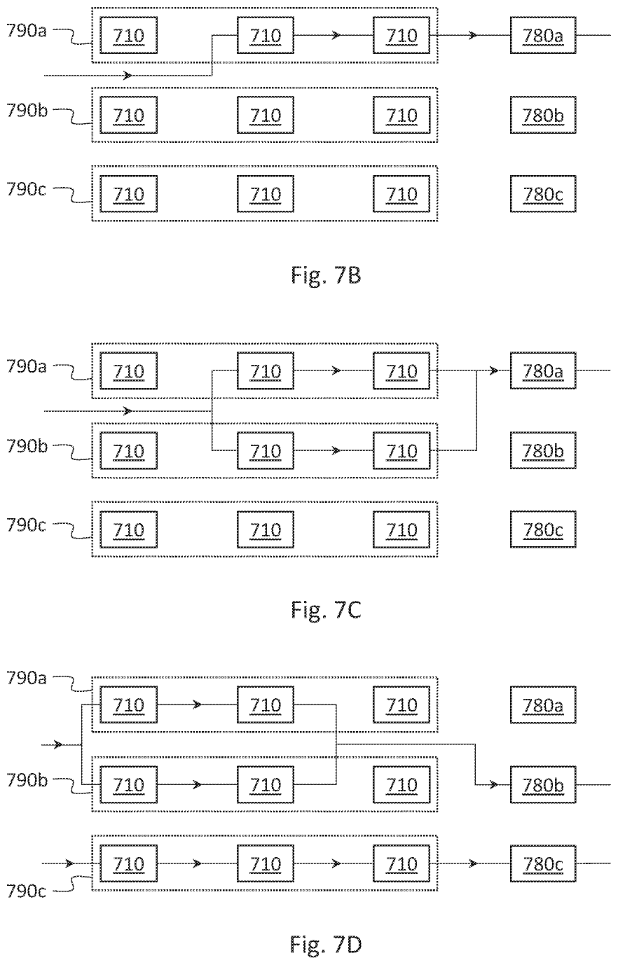

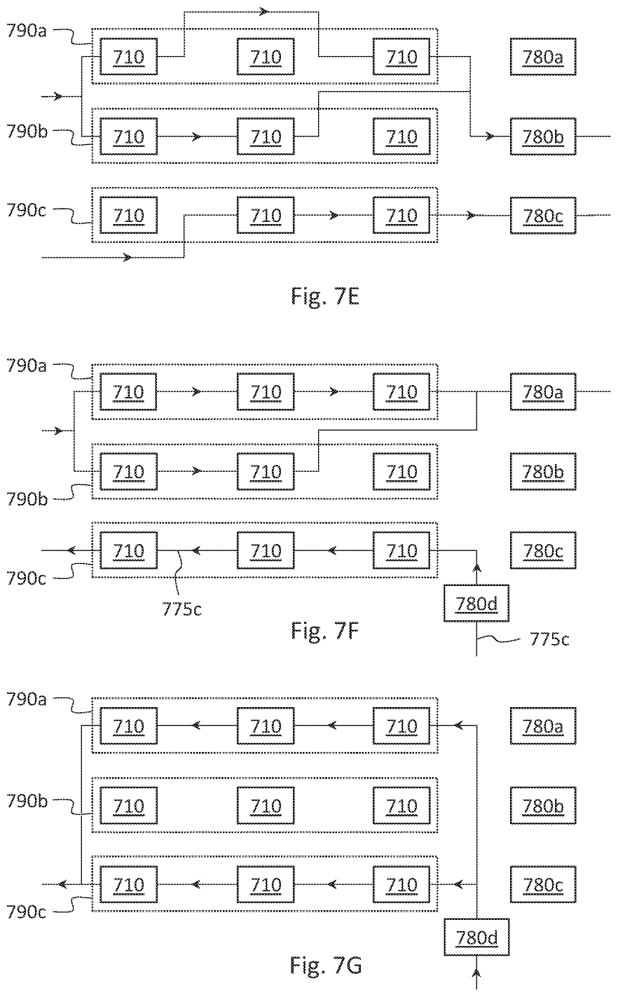

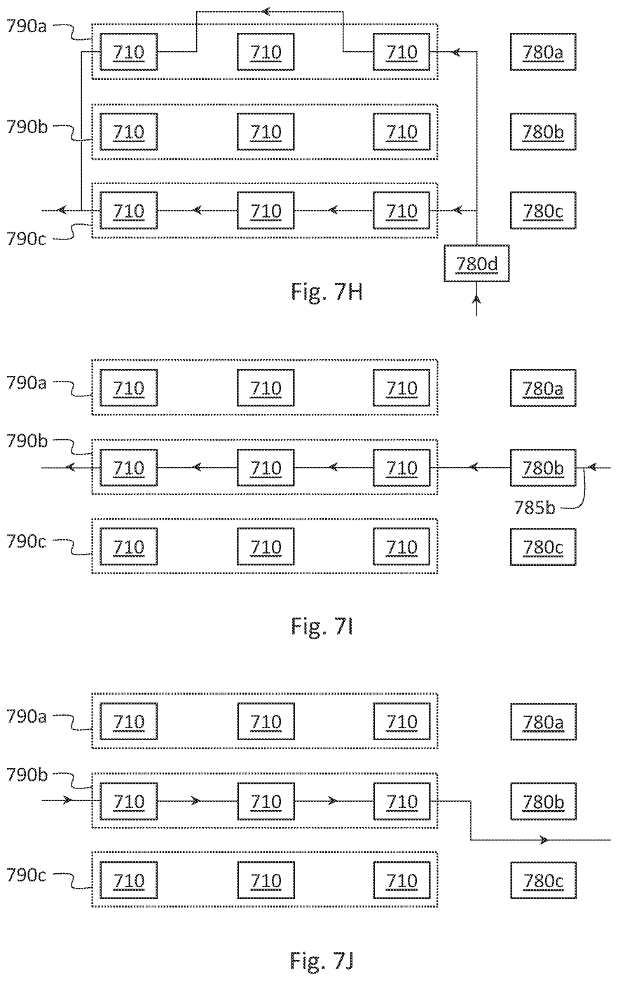

All of the above options (i.e. of shapes, forms, and chemistries) are covered by the scope of the disclosure. That is, each option represents separate embodiments of PSD 110. Further, disclosed PSD arrays, such as the PSD arrays depicted in FIGS. 6-7J, are not limited to including a single type of PSDs. That is, different PSDs in the disclosed PSD arrays, according to some embodiments, may differ from one another in shape, form, and chemistry. Different combinations of the above options (e.g. a LiCoO₂ battery and NiCad battery in a two-cell array) correspond to separate embodiments.

First switching module 106a is electrically-coupled to PSD 110 in series along a first line 105 extending between a first junction A and a second junction B. PSD 110 is positioned on first line 105 such that a positive polarity of PSD 110 points in the A-to-B direction (i.e. PSD 110 includes a negative terminal 120a and a positive terminal 120b of PSD 110; of the two terminals negative terminal 120a is the more closely positioned to first junction A). Second switching module 106b is positioned along a second line 115 extending from first junction A to second junction B, and is thus electrically-coupled (electrically-connected) to PSD 110 (and first switching module 106a) in parallel. Each of switching modules 106 may be switched between four module states S₀, S₁, S₂, and S₃. In the module state S₁, current flow through the switching module, from second junction B to first junction A, is blocked. That is, in the module state S₁, current can only be conducted through the switching module from first junction A to second junction B. Thus, when first switching module 106a is in the module state S₁ current can flow through first line 105 from first junction A to second junction B but not from second junction B to first junction A. Similarly, when second switching module 106b is in the module state S₁, current can flow through second line 115 from first junction A to the second junction B but not from second junction B to first junction A.

In the module state S₂, current flow through the switching module, from first junction A to second junction B, is blocked. Thus, when first switching module 106a is in the module state S₂, current can flow through first line 105 from second junction B to first junction A but not from first junction A to second junction B. Similarly, when second switching module 106b is in the module state S₂, current can flow through second line 115 from second junction B to first junction A but not from first junction A to second junction B.

In the module state S₃, current may be conducted through the switching module, both from first junction A to second junction B and vice-versa. Thus, when first switching module 106a is in the module state S₃, current can flow through first line 105 both from second junction B to first junction A and from first junction A to second junction B (one direction at a time). Similarly, when second switching module 106b is in the module state S₃, current can flow through second line 115 from second junction B to first junction A and from first junction A to second junction B (one direction at a time).

In the module state S₀, current cannot be conducted through the switching module. Thus, when first switching module 106a is in the module state S₀, current cannot flow through first line 105. Similarly, when second switching module 106b is in the module state S₀, current cannot flow through second line 115.

Switch system 100 is configured such that (joint) states (S₁, S₂), (S₁, S₃), (S₃, S₂), and (S₃, S₃) of switching modules 106 are precluded (i.e. inaccessible at the level of software and/or hardware). The first entry in each pair of brackets denotes the module state of first switching module 106a and the second entry in each pair of brackets denotes the module state of second switching module 106b. (Thus, for example, in the (joint) state (S₃, S₀) first switching module 106a is in the state S₃ and second switching module 106b is in the state S₀.)

Crucially, the preclusion of the states (S₁, S₂), (S₁, S₃), (S₃, S₂), and (S₃, S₃) prevents the possibility of short-circuit by discharge of PSD 110 onto itself—that is, a situation in which current is conducted by PSD 110 clockwise in a loop (from first junction A to second junction B via first line 105 and back from second junction B to first junction A via second line 115)—and, as such, constitutes a central safety feature of switch system 100.

It is noted that when first switching module 106a is in the state S₀—that is, when PSD 110 is bypassed (or more generally disabled)—PSD 110 may safely be removed (i.e. disconnected from first line 105), e.g. for maintenance purposes, or if damaged, or otherwise underperforming, in order to be replaced. Thus, in embodiments including a plurality of PSD 110, which are serially connected and are each associated with a respective pair of switching modules 106 (as described below in the description of FIGS. 6-7J), each of the PSDs may be removed without necessitating bypassing (or otherwise disabling) of any of the other PSDs, so that charging or discharging thereof is advantageously not interrupted.

According to some embodiments, PSD 110 is an electric vehicle (EV) cell, battery module, or/and battery pack, for example, an electric passenger car battery pack, an electric motorcycle battery pack, an electric van battery pack, or an electric truck battery pack. According to some embodiments, PSD 110 is a second-life EV battery pack.

Monitoring equipment 108 may include monitoring electronics, such as an ammeter, a voltmeter, an ohmmeter, a capacitance meter, and/or the like. According to some embodiments, monitoring equipment 108 may further include a thermometer, and/or a pressure meter. Monitoring equipment 108 is configured to monitor one or more electrical parameters, and optionally physical parameters, of PSD 110, and to send the monitored values to controller 102. More precisely, from monitored values obtained by monitoring equipment 108, and sent to controller 102, values of one or more electrical parameters, and optionally one or more physical parameters, may be derived (unless measured directly by monitoring equipment 108, in which case no derivation is required). The electrical parameters may include one or more of a state-of-charge (SoC), a remaining capacity, a resistance, a capacitance, and a charge and/or discharge rate of PSD 110, and/or a voltage there across (i.e. the potential difference between the terminals of PSD 110). The physical parameters may include one or more of a temperature of PSD 110 (e.g. temperature within PSD 110) and a pressure within PSD 110.

According to some embodiments, switch system 100 includes PSD 110.

FIGS. 1B-1D depict successive circuit states in the bypassing (i.e. circumvention) of a discharging PSD, according to some embodiments. FIG. 1B is a circuit diagram of switch system 100 (controller 102 and monitoring equipment 108 are not shown) during PSD 110 discharge. In FIG. 1B the pair of switching modules 106 is in the state (S₃, S₀) (or (S₁, S₀)) with a current/flowing through first line 105 in the A-to-B direction (and no current, or essentially no current, flowing through second line 115). FIG. 1C is a circuit diagram of switch system 100 in a transition state, wherein current flows through second line 115 but PSD 110 is yet to be fully bypassed (so that current still flows through first line 105). In FIG. 1C the pair of switching modules 106 is shown in the state (S₁, S₁) (or (S₃, S₁)) with the current I divided between first line 105 and second line 115. A current I₁ is flowing through first line 105 in the A-to-B direction and a complementary current I₂=I−I₁ is flowing through second line 115 in the A-to-B direction. According to some embodiments, I₁ and I₂ may be equal or substantially equal. FIG. 1D is a circuit diagram of switch system 100 with PSD 110 bypassed. In FIG. 1D the pair of switching modules 106 is in the state (S₀, S₃) (or (S₀, S₁)) with the current/flowing through second line 115 in the A-to-B direction.

To enable PSD 110 so as to reach a circuit state, wherein PSD 110 is discharging, from an initial circuit state, wherein current flows in the A-to-B direction through second line 115, the order of switching operations described above with respect to FIGS. 1B-1D may be inverted.

FIGS. 1E-1G depict successive circuit states in the bypassing of a charging PSD, according to some embodiments. FIG. 1E is a circuit diagram of switch system 100 (controller 102 and monitoring equipment 108 are not shown) during PSD 110 charge. In FIG. 1E the pair of switching modules 106 is in the state (S₃, S₀) (or (S₂, S₀)) with a current I′ flowing through first line 105 in the B-to-A direction (and no current, or essentially no current, flowing through second line 115). FIG. 1F is a circuit diagram of switch system 100 in a transition state, wherein current flows through second line 115 but PSD 110 is yet to be fully bypassed (so that current still flows through first line 105). In FIG. 1F the pair of switching modules 106 is shown in the state (S₂, S₂) (or (S₂, S₃)) with the current I′ divided between first line 105 and second line 115. A current I₁′ is flowing through first line 105 in the B-to-A direction and a complementary current I₂′=I′−I₁′ is flowing through second line 115 in the B-to-A direction. According to some embodiments, I₁′ and I₂′ may be equal or substantially equal. FIG. 1G is a circuit diagram of switch system 100 with PSD 110 bypassed. In FIG. 1G the pair of switching modules 106 is in the state (S₀, S₃) (or (S₀, S₂)) with the current I′ flowing through second line 115 in the B-to-A direction.

To enable PSD 110 so as to reach a circuit state, wherein PSD 110 is charging, from an initial circuit state, wherein current flows in the B-to-A direction through second line 115, the order of switching operations described above with respect to FIGS. 1E-1G may be inverted.

The inclusion of intermediate (transition) circuit states, wherein the current is partitioned between first line 105 and second line 115—as opposed to switching directly from a state wherein current flows in only one of the lines and immediately after only in the other line—is designed to prevent dips in the current during the transition, and thus constitutes an additional layer of safety (beyond the prevention of short-circuits induced by discharging of PSD 110 onto itself) provided by switch system 100. More specifically, and as elaborated on in the description of FIGS. 6-7J, given a plurality of PSDs (such as a plurality of PSD 110)—manufactured to the same specification and which when enabled are connected in series—and associated pairs of switching modules (such as the pair of switching modules 106), the bypassing of one of the PSDs, via an intermediate circuit state, as described above, will advantageously not lead to, or at least minimize, any dip in the current. This may be especially crucial when the PSDs are used to power a load, since sharp dips in the current may result in direct and/or indirect damage to the load.

According to some alternative embodiments, to bypass PSD 110 starting at an initial circuit state wherein PSD 110 is charging, controller 102 may be configured to switch the pair of switching modules 106 directly from (S₃, S₀) to (S₀, S₃) without transitioning through either of the intermediate circuit states wherein the current (flows in the B-to-A direction and) is partitioned between first line 105 and second line 115 (i.e. without switching the pair of switching modules 106 through the either of the joint states (S₂, S₂) and (S₂, S₃)).

According to some alternative embodiments, to initiate charging of PSD 110 starting at an initial circuit state wherein PSD 110 is bypassed and current flows in the B-to-A direction through second line 115, controller 102 may be configured to switch the pair of switching modules 106 directly from (S₀, S₃) to (S₃, S₀) without transitioning through either of the intermediate circuit states, wherein the current (flows in the B-to-A direction and) is partitioned between second line 115 and first line 105.

One scenario, wherein direct switching to bypass a charging PSD, or to enable a bypassed PSD to a state wherein the PSD is charging, may be tenable, is when the PSD forms part of a small number of coupled PSDs (e.g. two or three PSDs). Consequently, the direct switching does not incur a significant dip or spike in the current, so that risk of damage to the PSDs is small (as compared to the case wherein the number of coupled PSDs is large).

According to some embodiments, controller 102 may include a processor and a memory (not shown). The processor may be configured to decide when to bypass or enable PSD 110 based on monitoring data received from monitoring equipment 108. For example, the processor may be configured to determine a SoC of PSD 110, and/or a remaining capacity thereof, and accordingly decide to bypass PSD 110 (e.g. when PSD 110 is discharging and is nearly depleted or when PSD 110 is charging and nearly fully charged). According to some embodiments, and as elaborated on below in the description of FIGS. 6-7J, wherein PSD 110 forms part of an array of PSDs (which are all functionally associated with controller 102), controller 102 may be configured to determine whether to disable (e.g. circumvent) or enable PSD 110, and more generally each of the PSDs, so as, for instance, to power most efficiently a load (whether DC or AC) and/or charge most quickly a load.

According to some embodiments, controller 102 may be configured to instruct the pair of switching modules 106 to bypass PSD 110, when the voltage across PSD 110 (as measured by monitoring equipment 108) exceeds an upper threshold and/or drops below a lower threshold. Similarly, according to some embodiments, controller 102 may be configured to instruct the pair of switching modules 106 to bypass PSD 110, when the temperature of PSD 110 (as measured by monitoring equipment 108) exceeds a threshold temperature and/or the pressure within PSD 110 (as measured by monitoring equipment 108) exceeds a threshold pressure.

According to some embodiments, controller 102 may further include a timer (not shown; which may be part of the processor) allowing to order the switching operations, described in FIGS. 1B-1D and in FIGS. 1E-1G. Further, the timer may be used in computing the capacities of the PSDs.

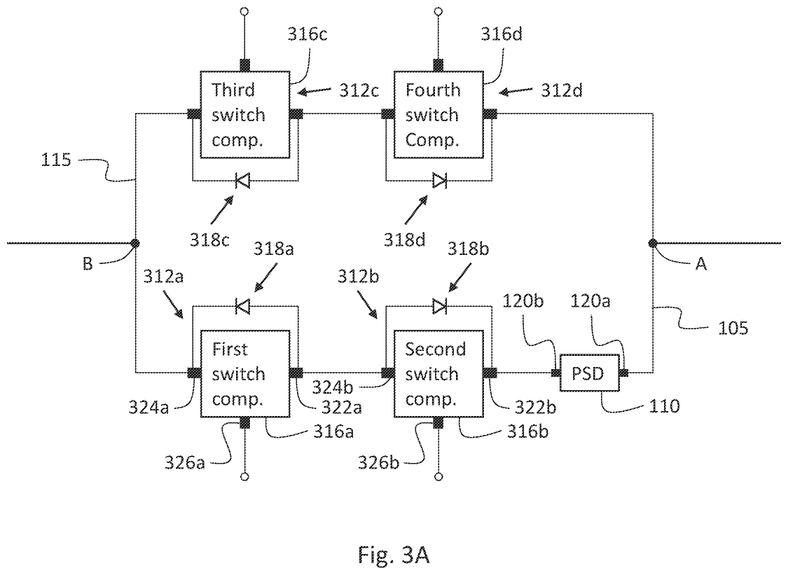

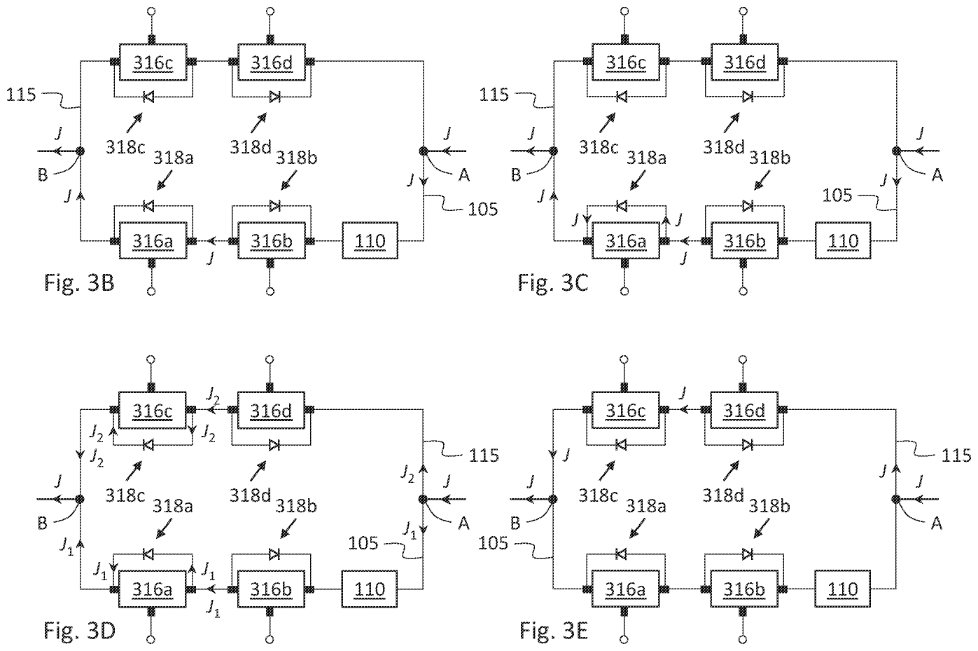

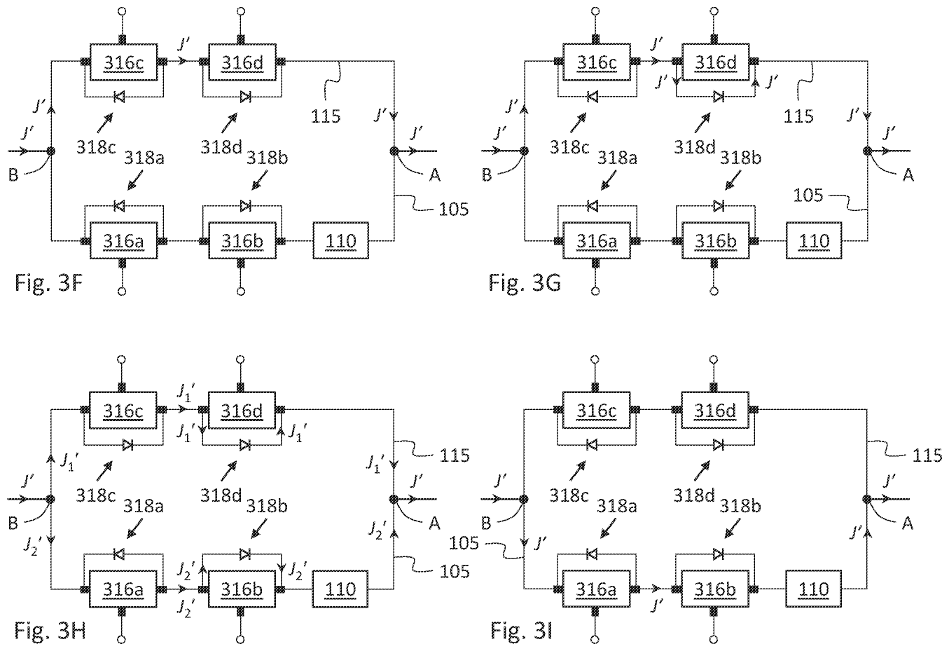

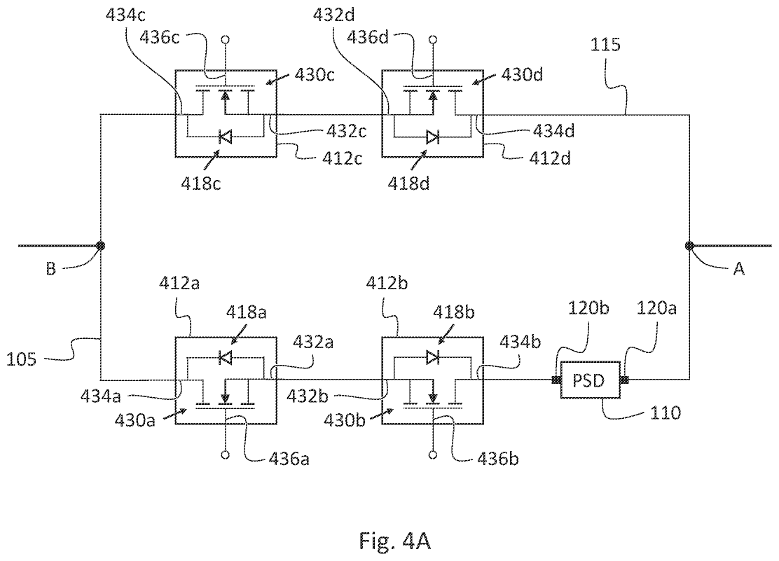

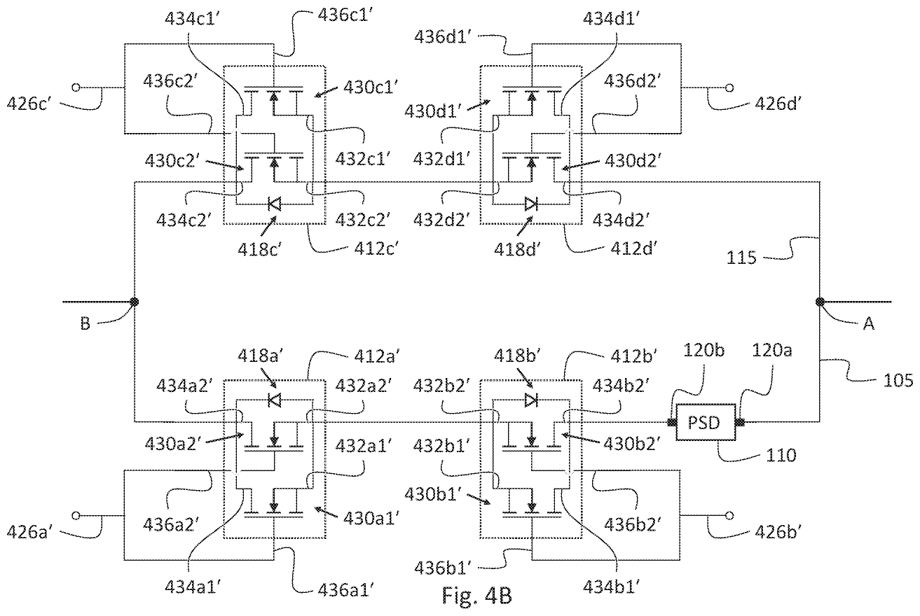

It is noted that the time intervals between successive switching operations in the sequence depicted in FIGS. 1B-1D, and the reverse sequence of switching operations, are in principle arbitrary so long as: The pair of switching modules 106 passes through the state (S₁, S₁) (or (S₃, S₁)) with the current divided between first line 105 and second line 115, as depicted in FIG. 1C (i.e. when bypassing PSD 110, starting from a state in which PSD 110 is discharging, or enabling PSD 110, starting from a state in which PSD 110 is bypassed and current flows through second line 115 in the A-to-B direction). Similarly, the time intervals between successive switching operations in the sequence depicted in FIGS. 1E-1G, and the reverse sequence of switching operations, are in principle arbitrary so long as: The pair of switching modules 106 passes through the state (S₂, S₂) (or (S₂, S₃)) with the current being divided between first line 105 and second line 115, as depicted in FIG. 1F (i.e. when bypassing PSD 110, starting from a state in which PSD 110 is charging, or enabling PSD 110, starting from a state in which PSD 110 is bypassed and current flows through second line 115 in the B-to-A direction). Advantageously, this implies that highly-accurate synchronization between first switching module 106a and second switching module 106b is not required. Consequently, first switching module 106a and second switching module 106b need not be “identical” in the sense of being manufactured to the same specification. As a non-limiting example intended to illustrate this last point, according to some embodiments, first switching module 106a may be transistor-based (e.g. as described below in the description of FIGS. 3A-4B), while second switching module 106b may be relay-based (e.g. as described below in the description of FIGS. 3A-3I), or vice-versa.

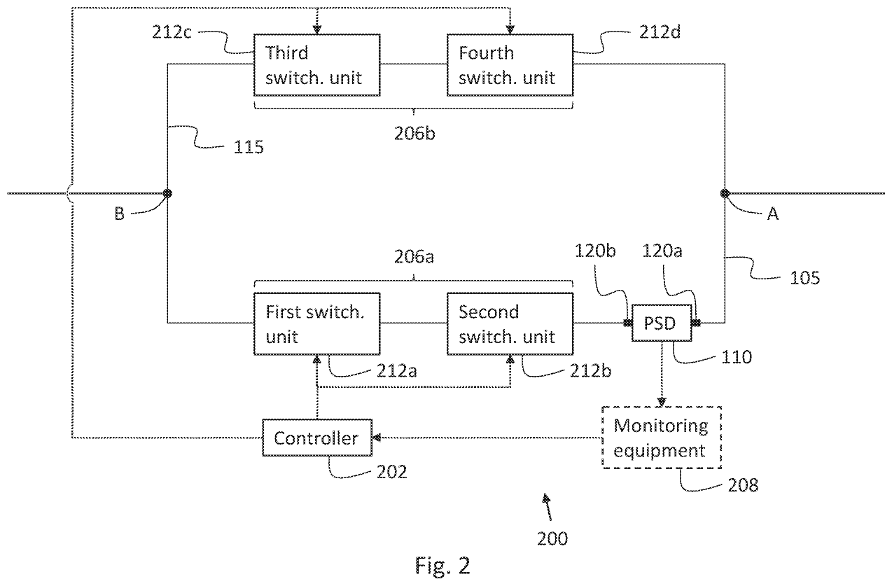

Referring to FIG. 2, FIG. 2 is a combined block-circuit diagram of a switch system 200 for one or more rechargeable power storage devices (PSDs), according to some embodiments. Switch system 200 is a specific embodiment of switch system 100, wherein each of the switching modules includes a pair of serially-coupled (i.e. connected in series) switching units. More specifically, switch system 200 includes a first switching module 206a and a second switching module 206b, which are specific embodiments of first switching module 106a and second switching module 106b, respectively. Further indicated are a controller 202 and monitoring equipment 208, which are specific embodiments of controller 102 and monitoring equipment 108.

First switching module 206a includes a first switching unit 212a and a second switching unit 212b. Switching units 212a and 212b are positioned on first line 105 and are serially-coupled to one another. Second switching module 206b includes a third switching unit 212c and a fourth switching unit 212d. Switching units 212c and 212d are positioned on second line 115 and are serially-coupled to one another.

According to some embodiments, each of switching units 212 (i.e. switching units 212a, 212b, 212c, and 212d) is switchable between a pair of states. First switching unit 212a may be switchable between a one-way conduction state M_{AB} and a two-way conduction state M. When first switching unit 212a is in the state M_{AB}, current is capable of flowing therethrough only in the A-to-B direction. When first switching unit 212a is in the state M, current is capable of flowing therethrough both in the A-to-B and B-to-A directions (one at a time). Second switching unit 212b may be switchable between a one-way conduction state M_{BA} and the two-way conduction state M. When second switching unit 212b is in the M_{BA} state, current is capable of flowing therethrough only in the B-to-A direction. When second switching unit 212a is in the state M, current is capable of flowing therethrough both in the A-to-B and B-to-A directions (one at a time).

Thus, when switching units 212a and 212b are in the states M_{AB} and M_{BA}, respectively, current cannot flow through first line 105, and first switching module 206a is in the module state S₀. When switching units 212a and 212b are in the states M_{AB} and M, respectively, current cannot flow through first line 105 in the B-to-A direction, and first switching module 206a is in the module state S₁. When switching units 212a and 212b are in the states M and M_{BA}, respectively, current cannot flow through first line 105 in the A-to-B direction, and first switching module 206a is in the module state S₂. When switching units 212a and 212b are each in the state M, current can flow through first line 105 both in the A-to-B and B-to-A directions, and first switching module 206a is in the module state S₃.

Similarly, third switching unit 212c may be switchable between the one-way conduction state M_{AB} and the two-way conduction state M. Fourth switching unit 212d may be switchable between the one-way conduction state M_{BA} and the two-way conduction state M.

Thus, when switching units 212c and 212d are in the states M_{AB} and M_{BA}, respectively, current cannot flow through second line 115, and second switching module 206b is in the module state S₀. When switching units 212c and 212d are in the states M_{AB} and M, respectively, current cannot flow through second line 115 in the B-to-A direction, and second switching module 206b is in the module state S₁. When switching units 212c and 212d are in the states M and M_{BA}, respectively, current cannot flow through second line 115 in the A-to-B direction, and second switching module 206b is in the module state S₂. When switching units 212c and 212d are each in the state M, current can flow through second line 115 both in the A-to-B and B-to-A directions, and second switching module 206b is in the module state S₃.

Table 1 identifies each of the possible composite states formed by pairs of states selected from M_{AB}, M_{BA}, and M with the module states S₀, S₁, S₂, and S₃. The entries on the leftmost column correspond to the possible states of a first switching unit (e.g. first switching unit 212a) in a switching module (e.g. first switching module 206a) and the entries on the top row correspond to the possible states of the second switching unit (e.g. second switching unit 212b) in the switching module.

TABLE 1

| | M_{BA} | M |
|---|---|---|
| M_{AB} | S₀ | S₁ |
| M | S₂ | S₃ |

Referring to FIG. 3A, FIG. 3A is a circuit diagram depicting switching units 312, according to some embodiments. Switching units 312 are specific embodiments of switching units 212 and are similarly positioned on lines 105 and 115. That is, a first switching unit 312a and a second switching unit 312b—which are specific embodiments of first switching unit 212a and second switching unit 212b, respectively—are serially-coupled and positioned on first line 105. A third switching unit 312c and a fourth switching unit 312d—which are specific embodiments of third switching unit 212c and fourth switching unit 212d, respectively—are serially-coupled and positioned on second line 115.

Each of switching units 312 may include a switch component and a diode. According to some embodiments, and as depicted in FIG. 3A, each of the switch components may include three terminals: a first terminal, a second terminal, and a control terminal. The control terminal is coupled to a controller (not shown in FIG. 3A), which is a specific embodiment of controller 202. The control terminal may be used to control the current flow through the switch component, as elaborated on below.

More specifically, according to some embodiments, first switching unit 312a includes a first switch component 316a and a first diode 318a, second switching unit 312b includes a second switch component 316b and a second diode 318b, third switching unit 312c includes a third switch component 316c and a third diode 318c, and fourth switching unit 312d includes a fourth switch component 316d and a fourth diode 318d. As elaborated on below, first diode 318a and second diode 318b are configured to block current in opposite directions, respectively. Similarly, third diode 318c and fourth diode 318d are configured to block current in opposite directions, respectively.

First switch component 316a includes a first terminal 322a, a second terminal 324a, and a control terminal 326a. First diode 318a is mounted between first terminal 322a and second terminal 324a, so as to be effectively connected in parallel to first switch component 316a. First diode 318a is configured to allow for current flow therethrough only in the A-to-B direction (that is, from first terminal 322a to second terminal 324a). Second switch component 316b includes a first terminal 322b, a second terminal 324b, and a control terminal 326b. Second diode 318b is mounted between first terminal 322b and second terminal 324b, so as to be effectively connected in parallel to second switch component 316b. Second diode 318b is configured to allow for current flow therethrough only in the B-to-A direction (that is, from second terminal 324b to first terminal 322b).

When first switching unit 312a is in the state M_{AB}, current is capable of flowing therethrough only in the A-to-B direction (via first diode 318a). When first switching unit 312a is in the state M, current is capable of flowing therethrough in the B-to-A direction through first switch component 316a, and in the A-to-B direction through first switch component 316a as well as through first diode 318a. In the latter case, the ratio of the current through first diode 318a to the current through first switch component 316a is dependent on the ratio of the respective resistances thereof. According to some embodiments, first switching unit 312a is configured such that this ratio is small, so as to avoid loss of power due to the resistance of first diode 318a.

When second switching unit 312b is in the state M_{BA}, current is capable of flowing therethrough only in the B-to-A direction (via second diode 318b). When second switching unit 312b is in the state M, current is capable of flowing therethrough in the A-to-B direction through second switch component 316b, and in the B-to-A direction through second switch component 316b as well as second diode 318b. In the latter case, the ratio of the current through second diode 318b to the current through second switch component 316b is dependent on the ratio of the respective resistances thereof. According to some embodiments, second switching unit 312b is configured such that this ratio is small, so as to avoid loss of power due to the resistance of second diode 318b.

Similarly, third switch component 316c includes three terminals (not numbered) with third diode 318c being mounted between the first and second terminals of third switch component 316c, so as to be effectively connected in parallel thereto. Third diode 318c is configured to allow for current flow therethrough only in the A-to-B direction. Fourth switch component 316d includes three terminals (not numbered) with fourth diode 318d being mounted between the first and second terminals of fourth switch component 316d, so as to be effectively connected in parallel thereto. Fourth diode 318d is configured to allow for current flow therethrough only in the B-to-A direction.

When third switching unit 312c is in the state M_{AB}, current is capable of flowing therethrough only in the A-to-B direction (via third diode 318c). When third switching unit 312c is in the state M, current is capable of flowing therethrough in the B-to-A direction through third switch component 316c, and in the A-to-B direction through third switch component 316c as well as through third diode 318c. In the latter case, the ratio of the current through third diode 318c to the current through third switch component 316c is dependent on the ratio of the respective resistances thereof. According to some embodiments, third switching unit 312c is configured such that this ratio is small, so as to avoid loss of power due to the resistance of third diode 318c.

When fourth switching unit 312d is in the state M_{BA}, current is capable of flowing therethrough only in the B-to-A direction (via fourth diode 318d). When fourth switching unit 312d is in the state M, current is capable of flowing therethrough in the A-to-B direction through fourth switch component 316d, and in the B-to-A direction through fourth switch component 316d as well as fourth diode 318d. In the latter case, the ratio of the current through fourth diode 318d to the current through fourth switch component 316d is dependent on the ratio of the respective resistances thereof. According to some embodiments, fourth switching unit 312d is configured such that this ratio is small, so as to avoid loss of power due to the resistance of fourth diode 318d.

According to some embodiments, each of switch components 316 may be, or include, a transistor, a relay, a contactor, and/or a combination of thereof. According to some such embodiments, all of switch components 316 are transistors. According to some alternative embodiments, all of switch components 316 are relays or all of switch components 316 are contactors. According to still other embodiments, some of switch components 316 may be, for example, transistors, and some of switch components 316 may be, for example, relays.

According to some embodiments, one or more of switch components 316 may be a field-effect transistor (FET) with the control terminal of each such switch component being constituted by the gate of the FET. According to some embodiments, one or more of switch components 316 may be a bipolar junction transistor (BJT) with the control terminal of each such switch component being constituted by the base of the BJT.

According to some embodiments, one or more of switch components 316 may be an AC power transistor.

According to some embodiments, one or more of switch components 316 may be a solid state relay, an electrochemical relay, a DC relay, or an AC relay.

FIGS. 3B-3E depict successive circuit states in the bypassing of PSD 110 starting at an initial state wherein PSD 110 is discharging, according to some example embodiments. In FIG. 3B switching units 312 are in the (collective) state (M, M, M_{AB}, M_{BA}) with a current J flowing through first line 105 in the A-to-B direction (and no current, or essentially no current, flowing through second line 115). The first entry in the brackets denotes the state of first switching unit 312a (i.e. first switching unit 312a is in the state M), the second entry in the brackets denotes the state of second switching unit 312b (i.e. second switching unit 312b is in the state M), the third entry in the brackets denotes the state of third switching unit 312c (i.e. third switching unit 312c is in the state M_{AB}), and the fourth entry in the brackets denotes the state of fourth switching unit 312d (i.e. fourth switching unit 312d is in the state M_{BA}). The current J may flow substantially only through switch components 316b and 316a with a comparatively negligible amount of the current flowing through first diode 318a (and virtually no current flowing through second diode 318b).

In FIG. 3C first switching unit 312a has been switched to the M_{AB} state. Thus, in FIG. 3C switching units 312 are in the state (M_{AB}, M, M_{AB}, M_{BA}) with the current J flowing through first line 105 in the A-to-B direction (and no current, or essentially no current, flowing through second line 115). The current J flows through second switch component 316b and first diode 318a (with virtually no current flowing through second diode 318b and first switch component 316a).

In FIG. 3D, in addition, fourth switching unit 312d has been switched to the M state. Thus, in FIG. 3D switching units 312 are in the state (M_{AB}, M, M_{AB}, M) with the current J being divided into a current J₁ flowing through first line 105 in the A-to-B direction and a complementary current J₂=J−J₁ flowing through second line 115 in the A-to-B direction. The current J₁ flows through second switch component 316b and first diode 318a (with virtually no current flowing through second diode 318b and first switch component 316a). The current J₂ flows through fourth switch component 316d and third diode 318c (with virtually no current flowing through fourth diode 318d and third switch component 316c).

In FIG. 3E, in addition, second switching unit 312b has been switched to the M_{BA} state and third switching unit 312c has been switched to the M state. Thus, in FIG. 3E switching units 312 are in the state (M_{AB}, M_{BA}, M, M) with the current J flowing through second line 115 in the A-to-B direction (and no current, or essentially no current, flowing through first line 105). The current J may flow substantially only through switch components 316d and 316c with a comparatively negligible amount of the current flowing through third diode 318c (and virtually no current flowing through fourth diode 318d).

While the bypassing of PSD 110 in FIGS. 3B-3E is described with respect to a specific sequence of circuit states, it is to be understood that this sequence of circuit states is not exclusive and other sequences of circuit states, which reflect different sequences of switching operations, are applicable. For example, the switching of first switching unit 312a to the M_{AB} state and the subsequent switching of fourth switching unit 312d to the M state may be performed simultaneously, in which case the sequence of circuit states would read: (M, M, M_{AB}, M_{BA}) (M_{AB}, M, M_{AB}, (M_{AB}, M_{BA}, M, M). As another example, the simultaneous switching of second switching unit 312b to the M_{BA} state and third switching unit 312c to the M state may be split into two successive switching operations. In general, any sequence of circuit states, which includes an intermediate circuit state, wherein the current J (flows from first junction A to second junction B and) is split between first line 105 and second line 115, is in principle applicable (with the caveat that the short-circuit states, listed earlier, are avoided).

To enable PSD 110 so as to reach a circuit state, wherein PSD 110 is discharging, from an initial circuit state, wherein current flows in the A-to-B direction through second line 115, the sequences of switching operations, described above with respect to FIGS. 3B-3E, may be inverted. More generally, it is to be understood that other sequences of circuit states are applicable, so long as including one or more intermediate states, as described in the previous paragraph.

FIGS. 3F-3I depict successive circuit states in the enabling of PSD 110 to a circuit state wherein PSD 110 is charging, starting from an initial circuit state, wherein current flows in the B-to-A direction through second line 115 (and no current or essentially no current flows through first line 105), according to some example embodiments. In FIG. 3F switching units 312 are in the (collective) state (M_{AB}, M_{BA}, M, M) with a current J′ flowing through second line 115 in the B-to-A direction. The current J′ may flow substantially only through switch components 316c and 316d with a comparatively negligible amount of the current flowing through fourth diode 318d (and virtually no current flowing through third diode 318c).

In FIG. 3G fourth switching unit 312d has been switched to the M_{BA} state. Thus, in FIG. 3G switching units 312 are in the state (M_{AB}, M_{BA}, M, M_{BA}) with the current J′ flowing through second line 115 in the B-to-A direction (and no current, or essentially no current, flowing through first line 105). The current J′ flows through third switch component 316c and fourth diode 318d (with virtually no current flowing through third diode 318c and fourth switch component 316d).

In FIG. 3H, in addition, first switching unit 312a has been switched to the M state, and PSD 110 begins charging. Thus, in FIG. 3H switching units 312 are in the state (M, M_{BA}, M, M_{BA}) with the current J′ being divided into a current flowing through second line 115 in the B-to-A direction and a complementary current J₂′=J′−J₁′ flowing through first line 105 in the B-to-A direction. The current flows through third switch component 316c and fourth diode 318d (with virtually no current flowing through third diode 318c and fourth switch component 316d). The current J₂′ flows through first switch component 316a and second diode 318b (with virtually no current flowing through first diode 318a and second switch component 316b).

In FIG. 3I, in addition, third switching unit 312c has been switched to the M_{AB} state and second switching unit 312b has been switched to the M state, so that the charging rate of PSD 110 is increased. Thus, in FIG. 3I switching units 312 are in the state (M, M, M_{AB}, M_{BA}) with the current J′ flowing through first line 105 in the B-to-A direction (and no current, or essentially no current, flowing through second line 115). The current J′ may flow substantially only through switch components 316a and 316b with a comparatively negligible amount of the current flowing through second diode 318b (and virtually no current flowing through first diode 318a).

While the enabling of PSD 110 in FIGS. 3F-3I is described with respect to a specific sequence of circuit states, it is to be understood that this sequence of circuit states is not exclusive and other sequences of circuit states, which reflect different sequences of switching operations, are applicable. For example, the switching of fourth switching unit 312d to the M_{BA} state and the subsequent switching of first switching unit 312a to the M state may be performed simultaneously, in which case the sequence of circuit states would read: (M_{AB}, M_{BA}, M, M) (M, M_{BA}, M, M_{BA}) (M, M, M_{AB}, M_{BA}). As another example, the simultaneous switching of third switching unit 312c to the M_{AB} state and second switching unit 312b to the M state may be split into two successive switching operations. In general, any sequence of circuit states, which includes an intermediate circuit state, wherein the current J′ (flows from second junction B to first junction A and) is split between second line 115 and first line 105 is in principle applicable (with the caveat that the short-circuit states, listed earlier, are avoided).

To bypass PSD 110 so as to reach a circuit state, wherein current flows in the B-to-A direction through second line 115, from an initial circuit state wherein PSD 110 is charging, the sequences of switching operations described above with respect to FIGS. 3F-3I may be inverted. More generally, is to be understood that other sequences of circuit states are applicable, so long as including one or more intermediate states, as described in the previous paragraph.

Referring to FIG. 4A, FIG. 4A is a circuit diagram depicting switching units 412, according to some embodiments. Switching units 412 are specific embodiments of switching units 312, wherein the respective switch component is a metal-oxide semiconductor FET (MOSFET). As a non-limiting example intended to render the discussion more concrete, in FIG. 4A, each of the MOSFETs is an N-channel enhancement-mode MOSFET. Diodes 418 are specific embodiments of diodes 318.

Switching units 412 include a first switching unit 412a, a second switching unit 412b, a third switching unit 412c, and a fourth switching unit 412d, which are specific embodiments of first switching unit 312a, second switching unit 312b, third switching unit 312c, and fourth switching unit 312d, respectively.

More specifically, according to some embodiments, and as depicted in FIG. 4A, a first MOSFET 430a, which is a specific embodiment of first switch component 316a, is positioned on first line 105 with a source-to-drain direction—defined by a source 432a and a drain 434a of first MOSFET 430a—pointing in the A-to-B direction, which is also the direction in which a first diode 418a (of first switching unit 412a) allows for current flow therethrough. A second MOSFET 430b, which is a specific embodiment of second switch component 316b, is positioned on first line 105 with a source-to-drain direction—defined by a source 432b and a drain 434b of second MOSFET 430b—pointing in the B-to-A direction, which is also the direction in which a second diode 418b (of second switching unit 412b) allows for current flow therethrough.

Similarly, a third MOSFET 430c, which is a specific embodiment of third switch component 316c, is positioned on second line 115 with a source-to-drain direction—defined by a source 432c and a drain 434c of third MOSFET 430c—pointing in the A-to-B direction, which is also the direction in which a third diode 418c (of third switching unit 412c) allows for current flow therethrough. A fourth MOSFET 430d, which is a specific embodiment of fourth switch component 316d, is positioned on second line 115 with a source-to-drain direction—defined by a source 432d and a drain 434d of fourth MOSFET 430d—pointing in the B-to-A direction, which is also the direction in which a fourth diode 418d (of fourth switching unit 412d) allows for current flow therethrough.

The above-described configurations of switching units 412 imply that for each of MOSFETs 430 the body diode (not shown) thereof, and the respective diode associated therewith from diodes 418, have the same polarity (i.e. allow for current in the same direction). That is, the body diode of first MOSFET 430a and first diode 418a have the same polarity, and so on. Alternatively, according to some embodiments, diodes 418 constitute the body diodes of MOSFETs 430, respectively (i.e. diode 418a constitutes he body diode of first MOSFT 430a, and so on).

In FIG. 4A MOSFETs 430a and 430b are shown such that the sources thereof are (directly) connected, but it will be understood that the converse option (wherein instead the drains are (directly) connected) is equally applicable. Similarly, MOSFETs 430c and 430d are shown such that the sources thereof are (directly) connected, but it will be understood that the converse option is equally applicable.

Also indicated are a gate 436a, a gate 436b, a gate 436c, and a gate 436d of first MOSFET 430a, second MOSFET 430b, third MOSFET 430c, and fourth MOSFET 430d, respectively. Each of MOSFETs 430 may be actuated (i.e. switched to the state M) by applying a voltage at the gate thereof (more precisely, generating potential difference between the gate and the source), which is greater than a threshold voltage.

While in FIG. 4A, each of the MOSFETs is depicted as an N-channel enhancement-mode MOSFET, it is to be understood that other options are possible. In particular, according to some embodiments, each of the MOSFETs may be a P-channel enhancement-mode MOSFET, in which case the associated diode will point in the drain-to-source direction (defined by the source and drain of the MOSFET). According to some embodiments, one of the two MOSFETs on a line may be an N-channel enhancement-mode MOSFET and the second MOSFET on the line may be a P-channel enhancement-mode MOSFET, in which case the drain of one of the MOSFETs will be connected to the source of the other MOSFET. According to some embodiments, the MOSFETs may be depletion-mode MOSFETs, in which case, to maintain a switching unit in the state M, no voltage needs to be applied at the gate.

Referring to FIG. 4B, FIG. 4B is a circuit diagram depicting switching units 412′, according to some embodiments. Switching units 412′ are similar to switching units 412, respectively, but differ therefrom in that each of switching units 412′ includes a plurality of MOSFETs (as a non-limiting example, two in FIG. 4B) connected in parallel to one another. According to some embodiments, and as depicted in FIG. 4B, each of the MOSFETs is an N-channel enhancement-mode MOSFET.

More specifically, according to some embodiments, and as depicted in FIG. 4B, in each of switching units 412′ the sources of the MOSFETs are connected to one another and the drains of the MOSFETs are connected to one another. Thus, in a first switching unit 412a′, sources 432a1′ and 432a2′ of a first MOSFET 430a1′ and a second MOSFET 430a2′ are connected, and drains 434a1′ and 434a2′ of first MOSFET 430a1′ and second MOSFET 430a2′ are connected. In a second switching unit 412b′, sources 432b1′ and 432b2′ of a first MOSFET 430b1′ and a second MOSFET 430b2′ are connected, and drains 434b1′ and 434b2′ of first MOSFET 430b1′ and second MOSFET 430b2′ are connected. In a third switching unit 412c′, sources 432c1′ and 432c2′ of a first MOSFET 430c1′ and a second MOSFET 430c2′ are connected, and drains 434c1′ and 434c2′ of first MOSFET 430c1′ and second MOSFET 430c2′ are connected. In a fourth switching unit 412d′, sources 432d1′ and 432d2′ of a first MOSFET 430d1′ and a second MOSFET 430d2′ are connected, and drains 434d1′ and 434d2′ of first MOSFET 430d1′ and second MOSFET 430d2′ are connected.

Also indicated in FIG. 4B are diodes 418a′, 418b′, 418c′, and 418d′ of switching units 412a′, 412b′, 412c′, and 412d′, respectively, and gates 436a1′, 436a2′, 436b1′, 436b2′, 436c1′, 436c2′, 436d1′, and 436d2′ of MOSFETS 430a1′, 430a2′, 430b1′, 430b2′, 430c1′, 430c2′, 430d1′, and 430d2′, respectively. According to some embodiments, the gates of the two MOSFETs in each of switching units 412′ (e.g. gates 436a1′ and 436a2′ in first switching unit 412a′) are connected, so that the two MOSFETs are jointly actuated by a single voltage signal at a single control terminal (e.g. control terminal 426a′ of first switching unit 412a′). According to some alternative embodiments, not depicted in FIG. 4B, the gates of the two MOSFETs in each of switching units 412′ (e.g. gates 436c1′ and 436c2′ of third switching unit 412c′) are not connected, such as to allow individual actuation of each of the two MOSFETs.

Also indicated are control terminals 426b′, 426c′, and 426d′ of switching units 412b′, 412c′, and 412d′, respectively.

Switching Methods

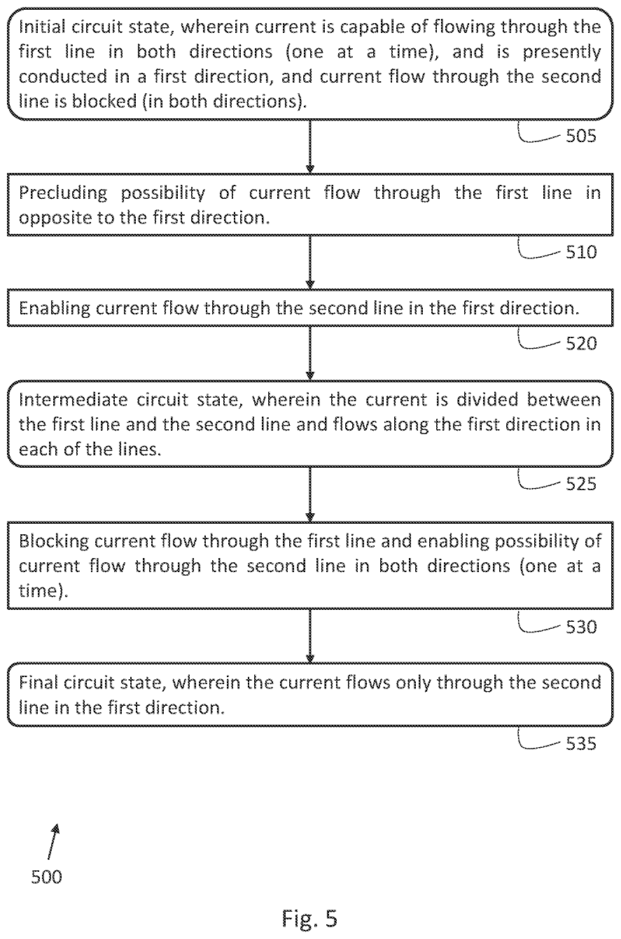

According to an aspect of some embodiments, there is provided a method for diverting current from a first line—having mounted thereon a PSD—to a second line, and vice-versa, the two lines extending from a first junction to a second junction. Put differently, the method allows bypassing (i.e. circumventing) a PSD and enabling the PSD starting from a circuit state wherein the PSD is bypassed. FIG. 5 is a flow chart of such a method, a method 500, according to some embodiments. In order to redirect current from a first of the two lines to the second line—starting at an initial circuit state 505, wherein (i) current is capable of being conducted through the first line in both directions (i.e. either upstream or downstream), and is presently conducted in a first direction, and (ii) current flow through the second line is blocked (in both directions)—method 500 may specify:
An operation 510, wherein possibility of current flow through the first line in opposite to the first direction is precluded.
An operation 520, wherein current flow through the second line is enabled only in the first direction, thereby transforming to an intermediate circuit state 525, wherein the current is divided between the first line and the second line and flows along the first direction in each of the lines.
An operation 530, wherein current flow through the first line is blocked and current flow through the second line is in principle enabled in both directions, thereby transforming to a final circuit state 535, wherein the current flows (only) through the second line in the first direction.

According to some embodiments, operations 510 and 520 may performed simultaneously. According to some embodiments, the order of operations 510 and 520 may be inverted. According to some embodiments, operation 530 may be performed in two stages: a first stage, wherein current flow through the first line is blocked, and a second stage, wherein current flow through the second line is in principle enabled in both directions, or vice-versa.

Method 500 may be implemented using switch system 100, and, in particular, any one of the specific embodiments thereof (described above). More specifically, method 500 may be implemented by mounting a first switching module, such as first switching module 106a, on the first line and a second switching module, such as second switching module 106b, on the second line, and utilizing the switching modules, as taught above in the Switch systems subsection.

Power Management Systems

FIG. 6 schematically depicts an energy storage 600 including a PSD array 660 and a power management system 650 (PMS), according to some embodiments. PMS 650 is configured to control and regulate charging and discharging of rechargeable PSDs 610 in PSD array 660. PSDs 610 may differ from one another in output voltages, output currents, and/or capacities. In particular, PSDs 610 may differ from one another in chemistry and/or conditions, i.e. state-of-health (SoH).

As used herein, the term “PSD array” is used to refer to an array of PSDs, that is, a plurality of PSDs. More specifically, according to some embodiments, the term “PSD array” may be used to refer to a plurality of PSDs that includes groups of interconnected or interconnectable PSDs. Thus, as non-limiting examples, a group may include a plurality of serially-connected PSDs and/or a plurality of PSDs connected in parallel. In addition, according to some embodiments, groups may be connected to one another, e.g. in parallel and/or in series. Most generally, the term “PSD array” may be used to refer to an array of PSDs whose interconnections may be controllably modified, such as to allow rewiring the array.

According to some embodiments, PSD array 660 may include repurposed battery modules or battery packs. That is, used battery modules or battery packs, which are no longer suitable for their original “roles”. According to some such embodiments, PSD array 660 may include second-life EV battery packs. That is, used EV battery packs, which are no longer employable as EV battery packs (e.g. due to reduced capacity and/or reduced charging rates).

As used herein, the term “electric vehicle” is to be understood in an expansive manner and may refer to any electrically-powered vehicle, whether manned or autonomous, that includes one or more rechargeable battery modules or rechargeable battery packs. The term “electric vehicle” should also be understood to cover any hybrid vehicle whose battery may be charged by plugging it into an external power source (using an external or on-board charger). In particular, the term “electric vehicle” should be understood to cover electric scooters, bikes, motorcycles, passenger cars, vans, buses, trucks, aircrafts (such as drones, as well as manned planes and choppers), boats, ships, marine vessels (such as tankers, freighters, and barges), and (electric) mobile industrial machinery (such as tractors and forklifts).

PMS 650 includes a controller 602, a switch assembly 656, and monitoring equipment 608. Also indicated is a DC-DC charger 680, which, according to some embodiments, is included in PMS 650. Switch assembly 656 includes pairs of switching modules 606 (not all of which are numbered). Each pair of switching modules 606 constitutes an embodiment of the pair of switching modules 106 (and is indicated by a single switch symbol). According to some embodiments, and as depicted in FIG. 6, each pair of switching modules 606 is functionally associated with a respective PSD from PSD array 660. Thus, for example a first pair of switching modules 606a is functionally associated with a first PSD 610a, a second pair of switching modules 606b is functionally associated with a second PSD 610b, and so on.

Controller 602 may be configured to enable and disable (by circumventing) each of PSDs 610 by switching the respective pair of switching modules between joint states (Sᵢ, Sⱼ), wherein Sᵢ and Sⱼ (i.e. i=0, 1, 2, 3 and j=0, 1, 2, 3) are the respective module states of the first and second switching modules in the pair, as taught above in the Switching systems and Switching methods subsections. More specifically, by selectively disabling and enabling PSDs in PSD array 660, PSD array 660 may be reconfigured to address changes in the status of individual PSDs in PSD array 660 and/or in the status of one or more rechargeable loads charged by PSD array 660.

Monitoring equipment 608 is configured to monitor SoCs and/or remaining capacities of PSDs 610 and to send the monitored values thereof to controller 602. Controller 602 is configured to controllably switch each pair of switching modules between the respective module states thereof based at least on the monitored SoC value and/or remaining capacity value of the respective PSD.

DC-DC charger 680 is associated with PSD array 660, so as to allow charging rechargeable loads of different voltages, and adjusting, if necessary, the voltage supplied to a rechargeable load as the SoC thereof is increased. According to some embodiments, DC-DC charger 680 may be bidirectional, so as to allow discharging a rechargeable load onto one or more of PSDs 610 (or to an external power source connectable to energy storage 600). According to some embodiments, energy storage 600 may include one or more additional DC-DC chargers. Each of the additional DC-DC chargers may be associated with PSD array 660, so as to allow simultaneously charging a plurality of rechargeable loads characterized by different charging voltages. According to some embodiments, the additional DC-DC chargers may be included in PMS 650.

PMS 650 may include additional switches (not shown) configured to allow selectively connecting PSDs in PSD array 660 to the DC-DC chargers.

According to some embodiments, energy storage 600 may be connectable to a power source (not shown). According to some embodiments, the power source may provide alternating current (AC)—for example, when the power source is a power grid—in which case the power source may be connected to energy storage via an AC-DC converter. According to some embodiments, the power source may provide a direct current (DC)—for example, when the power source is a renewable energy plant. In such embodiments, the power source may be directly connected to energy storage 600 (i.e. without an intermediate AC-DC converter). PMS 650 may be configured to allow selectively charging each of PSDs 610 from the power source. According to some embodiments, controller 602 may be configured to allow charging one or more PSDs in PSD array 660 while simultaneously discharging one or more other PSDs in PSD array 660.

According to some embodiments, based on charge requirements of one or more rechargeable loads, controller 602 is configured to decide, which of PSDs 610 is or are to be employed to charge the one or more rechargeable loads, such that one or more of a power consumption, charging time, and electricity cost is minimized, or substantially minimized, and/or a desired trade-off there between is achieved. The charge requirements may include charging voltages, charging currents, and/or charging powers of the loads. The charge requirements may further include amounts of charge requested by each of the loads.

According to some embodiments, energy storage 600 may further include a DC-AC charger(s) (not shown) functionally associated with controller 602, and configured to allow powering an AC load, and, in particular, charging a battery pack, which has its AC-DC charger built-in (such that it may only be connected to an AC current source). According to some embodiments, the DC-AC charger may be included in PMS 650.

According to some embodiments, energy storage 600 may be an EV charging station, e.g. a commercial EV charging station for servicing electric cars. According to some embodiments, energy storage 600 may be deployed at an airfield or a port in order to service electric aircrafts or electric watercrafts, respectively. According to some embodiments, energy storage 600 may be deployed at a construction site, a mining site, or even a farm, wherein EVs and/or electric mobile industrial machinery (e.g. a tractor, a forklift, a dumper) are used. According to some embodiments, energy storage 600 may be deployed at a parking lot, for example, an underground parking of an office building and/or a residential building.

FIG. 7A presents a circuit diagram illustrating electrical association between PSDs, DC-DC chargers, switching modules, and switches, in an energy storage 700, according to some embodiments. Energy storage 700 may be a specific embodiment of energy storage 600. Depicted are a PSD array, DC-DC chargers 780, and a switching assembly including a plurality of pairs of switching modules 706. The PSD array includes PSDs 710. Also depicted are switches 782, and pairs of electrical lines 705 (first lines, also referred to as “power lines”; not all of which are numbered) and 715 (second lines, also referred to as “bypass lines”; not all of which are numbered). Each pair of electrical lines is associated with one of the PSDs 710, respectively. The Switching assembly may be a specific embodiment of switching assembly 656. Switches 782 may be specific embodiments of the (additional) switches of PMS 650 (included in some embodiments thereof as described above). DC-DC chargers 780 may be specific embodiments of the DC-DC chargers of energy storage 600. The PSD array may be a specific embodiment of PSD array 660.

Thus, for example, a PSD 710′ on a second row is mounted on a first line 705′, on which a first switching module 706a′ is also mounted. A second switching module 706b′ is mounted on a second line 715′, in parallel to PSD 710′ and first switching module 706a′, as taught above in the description of FIGS. 1A-1G. When PSD 710′ is enabled, current is conducted through first line 705′. When PSD 710′ is bypassed, current is conducted through second line 715′, unless second row 790a is entirely disabled, in which case no current is conducted through neither of second line 715′ and first line 705′.

PSDs 710 are arranged in a rectangular n×m array. Each pair of adjacent PSDs in a row of the (PSD) array, when both enabled, are serially connected. As a non-limiting example, intended to render the discussion more concrete and facilitate the description, the number of rows n and the number of columns m are each taken to equal 3. That is, the PSD array is shown arranged in three rows 790: a first row 790a, a second row 790b, and a third row 790c, which are connected in parallel. Each of rows 790 includes three of PSDs 710, which when enabled are serially connected.

Similarly, in order to render the discussion more concrete and facilitate the description, DC-DC chargers 780 are assumed to include four DC-DC chargers: a first DC-DC charger 780a, a second DC-DC charger 780b, a third DC-DC charger 780c, and a fourth DC-DC charger 780d. According to some embodiments, switches 782 may include switching components (not shown), which are configured to allow selectively connecting one or more of rows 790 to any one of DC-DC chargers 780.

Also indicated are lines 786 and 788. Line 786 leads from switches 782 via fourth DC-DC charger 780d to an external power-source. Line 788 may be used to charge rechargeable load(s) (not shown) directly from the PSD array without passing through DC-DC chargers 780.

Also indicated are a positive terminal 720b′ and a negative terminal 720a′ of PSD 710′. The rest of the PSDs 710 are understood to be identically polarized, i.e. with a positive polarity of each of the PSDs pointing from the left of FIG. 7A to the right thereof. Finally, indicated are a first junction point A and a second junction point B between which each of first line 705′ and second line 715′ extend.

FIGS. 7B-7J respectively illustrate example wiring configurations of the PSD array of energy storage 700, allowed by the circuit architecture of FIG. 7A, according to some embodiments. The example configurations are intended to facilitate the description and should be understood to be non-exhaustive. That is, the example configurations constitute a small sample of the total number of possible wiring configurations. Each of the wiring configurations is realized by a respective actuation configuration of the switching assembly (and switches 782). Lines extending between elements represent electrical connection therebetween. “Stealth arrowheads” on the lines indicate the direction of current flow. Pairs of switching modules 706 and switches 782 are not shown in FIGS. 7B-7J.

A wiring configuration may be pre-selected by the controller. For example, prior to commencing a charging of a load(s), the controller may select a suitable wiring configuration. In addition, a wiring configuration may be switched to while the PMS is in the midst of fulfilling a task (e.g. a charge request). For example, during charging of a load(s), in response to one or more of the PSDs (used to charge the load(s)), nearing depletion, the controller may elect to bypass those PSDs and, optionally, enable other PSDs.

In FIG. 7B the two rightmost PSDs in first row 790a are enabled (i.e. each of the respective pairs of switching modules is in the state (S₃, S₀)), while the leftmost PSD is bypassed (i.e. the respective pair of switching modules is in the state (S₀, S₃). First row 790a is connected to first DC-DC charger 780a, which is used to charge one or more loads (having compatible charging specifications). The loads are not shown.

FIG. 7C differs from FIG. 7B in that the two rightmost PSDs in second row 790b are additionally enabled and also connected to first DC-DC charger 780a. The enabled PSDs in second row 790b are connected in parallel to the enabled PSDs in first row 790a.

It is noted that utilizing a plurality of rows, rather than a single row, to charge a load, allows for the increase of the charging current and therefore a commensurate decrease in the charging time (e.g. when the number of rows is doubled and the same number of PSDs are enabled in each row, potentially substantially halving the charging time when all of the enabled PSDs have been manufactured to the same specification). Alternatively, a plurality of rows, rather than a single row, may be utilized in order to reduce the charging current supplied by each of the PSDs.

In FIG. 7D the two leftmost PSDs in each of first row 790a and second row 790b are enabled, while the rightmost PSDs in first row 790a and second row 790b are bypassed. Each of first row 790a and second row 790b is connected to second DC-DC charger 780b, which is used to charge one or more loads (not shown). The enabled PSDs in first row 790a are connected in parallel to the enabled PSDs in second row 790b. Each of the PSDs in third row 790c is enabled. Third row 790c is connected to third DC-DC charger 780c, which is used to charge one or more other loads (not shown).

FIG. 7E differs from FIG. 7D in that the rightmost PSD in first row 790a is enabled, rather than bypassed, and the middle PSD in first row 790a is bypassed, rather than enabled. FIG. 7E further differs from FIG. 7D in that the leftmost PSD in third row 790c is bypassed, rather than enabled.

Example scenarios—in which the controller may elect to switch from the wiring configuration of FIG. 7D to that of FIG. 7E—include the middle PSD in first row 790a and/or the leftmost PSD in third row 790c approaching depletion before the rest of the enabled PSDs or overheating (while the temperatures of the rest of the enabled PSDs remain within normal limits). According to some embodiments, the enabling of the rightmost PSD in first row 790a may compensate for the bypassing of the middle PSD in first row 790a.

In FIG. 7F all the PSDs in first row 790a, and the two leftmost PSDs in second row 790b, are enabled, while the rightmost PSD in second row 790b is bypassed. Each of first row 790a and second row 790b is connected to first DC-DC charger 780a, which is used to charge one or more loads (not shown). The enabled PSDs in second row 790b are connected in parallel to the PSDs in first row 790a. Each of the PSDs in third row 790c is enabled. Third row 790c is connected, via line 786, to fourth DC-DC charger 780d, which, in turn, is connected to a power source (not shown), which is used to charge the PSDs in third row 790c, as indicated by arrows 775c.

In FIG. 7G all the PSDs in first row 790a and third row 790c are enabled. First row 790a and third row 790c are connected, via line 786, to fourth DC-DC charger 770d, which, in turn, is connected to the power source (not shown), which is used to charge the PSDs in first row 790a and third row 790c.

FIG. 7H differs from FIG. 7G in that the middle PSD in first row 790a is bypassed, rather than enabled, and is therefore not being charged.

Example scenarios—in which the computational module may elect to switch from the wiring configuration of FIG. 7G to that of FIG. 7H—include the middle PSD in first row 790a approaching saturation before the rest of the charging PSDs or a pressure therein exceeding a threshold pressure (while the pressures in the rest of the charging PSDs remain within normal limits).

In FIG. 7I all the PSDs in second row 790b are enabled. Second row 790b is connected to a second DC-DC charger 780b′, which is a specific embodiment second DC-DC charger 780b characterized by being bidirectional. The PSDs in second row 790b are being charged by one or more load(s) (not shown), which are connected to second DC-DC charger 780b′, as indicated by arrow 785b.

In FIG. 7J all the PSDs in second row 790b are enabled and are used to directly charge (i.e. without voltage conversion by any one of DC-DC chargers 780) one or more rechargeable loads (not shown).

It is to be understood that other circuit diagrams than the circuit diagram of FIG. 7A are covered by the scope of the disclosure. More generally, additional switches/switching modules may be included, which allow, for example, to connect two or more of rows 790 in series, or even redefine the rows (i.e. the groups of serially-connected or connectable PSDs). For instance, according to some embodiments, the rows may be controllably redefined, such that leftmost PSD in first row 790a, the middle PSD in second row 790b, and the rightmost PSD in third row 790c are serially-connectable, the middle PSD in first row 790a, the rightmost PSD in second row 790b, and the leftmost PSD in third row 790c are serially-connectable, and the rightmost PSD in first row 790a, the leftmost PSD in second row 790b, and the middle PSD in third row 790c are serially-connectable. Most generally, beyond increasing the number of PSDs and/or rows, additional switches/switching modules may be included, which allow each PSD to be controllably directly connected to any other of the PSDs.

Experimental Results

This section presents experimental results demonstrating the utility of the disclosed switch systems and methods.

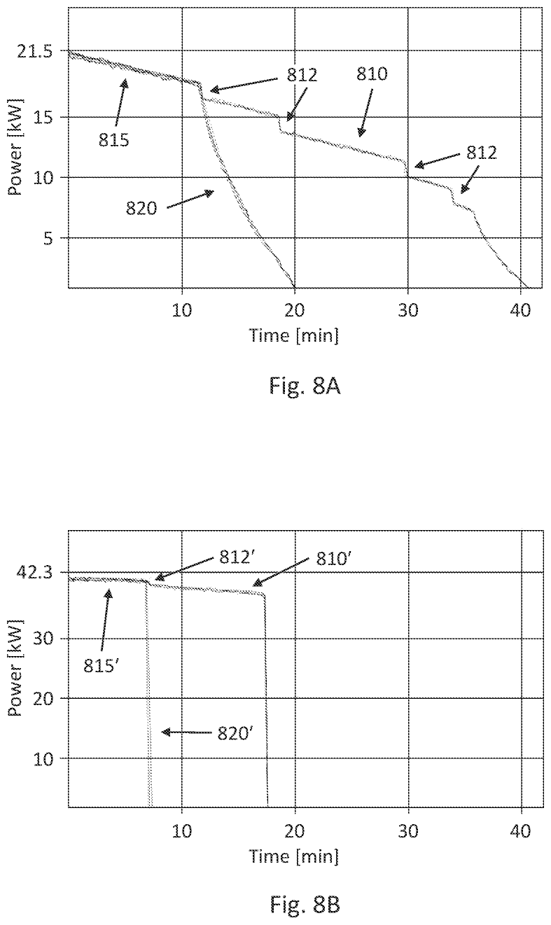

FIGS. 8A and 8B present experimental results obtained utilizing a prototype of a PMS, which is a specific embodiment of PMS 650. The prototype was installed on a battery pack including nine battery modules connected in parallel. Each of the battery modules included fourteen serially-connected cells. Nine switches of the prototype allowed individually addressing each battery module, and, in particular, disabling any of the battery modules while leaving the other battery modules enabled.

Referring to FIG. 8A, the prototype was operated in a constant current-mode (i.e. when a substantially fixed current is provided by the prototype). A first curve 810 depicts the power provided by the prototype as a function of time. Each battery module was monitored. When monitoring data indicated that a battery module was about to start underperforming (e.g. due to one of the cells in the battery module being about to underperform), that battery module was disabled. Each of near-vertical segments 812 indicates a small drop in the power provided by prototype due to a disabling of one of the battery modules, respectively.

A second curve 820 depicts the power provided by the prototype as a function of time without disabling any of the battery modules in response to a battery module starting to underperform. Second curve 820 thus mimics performance of prior-art battery packs, wherein the cells, or at least the battery modules, are not individually addressable. Consequently, underperformance of one battery module severely impacts the rest of the battery nodules: Within a short time period the battery modules are no longer capable of maintaining the magnitude of the current.

Thus, along a joint segment 815 (wherein none of the battery modules is underperforming) curves 810 and 820 overlap. However, when one of the battery modules starts underperforming, curves 810 and 820 diverge.

Referring to FIG. 8B, the prototype was operated in a constant power-mode (i.e. when a substantially fixed power is provided by the prototype). Similarly to FIG. 8A, a first curve 810′ depicts the power provided by the prototype as a function of time, while a second curve 820′ mimicked performance of prior-art battery packs, wherein the cells, or at least the battery modules, are not individually addressable.

Along a joint segment 815′ (wherein none of the battery modules is underperforming) curves 810′ and 820′ overlap. However, when one of the battery modules starts underperforming, curves 810′ and 820′ diverge. A “step” 812 indicates a slight drop in the power provided by prototype due to a disabling of one of the battery modules. In contrast, when the underperforming battery module cannot be disabled, its underperformance cannot be compensated for by the other battery modules, as attested by the sharp drop (in power) to zero of second curve 820′ beyond joint segment 815′. Put differently, to task the battery modules to keep operating in the constant power-mode would require the cells in the battery modules to decrease their output voltages under their minimum operating voltages, respectively.

In each of FIGS. 8A and 8B, even better performance of the prototype, and therefore greater advantage afforded thereby, is to be expected when each of the cells is individually addressable—in the sense of being equipped with a pair of switching modules, such as the pair of switching modules 106—since instead of disabling the battery module due to the underperformance of a cell, the cell may be bypassed (i.e. circumvented) instead.

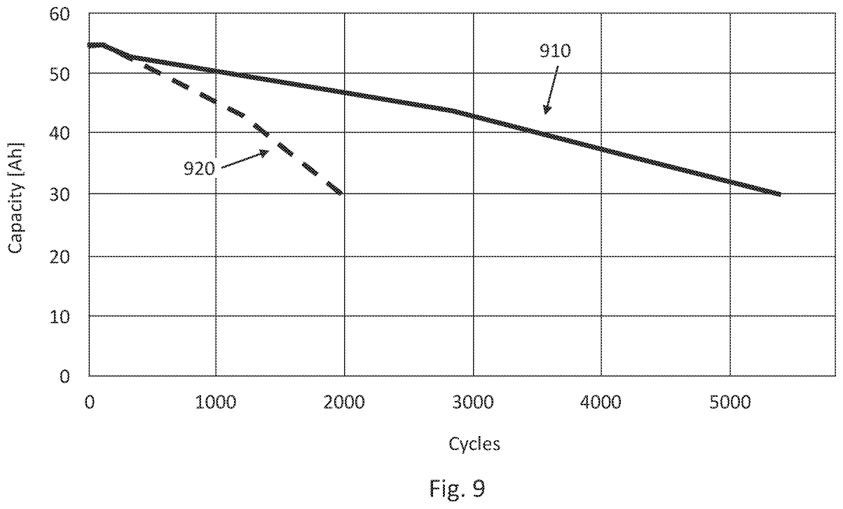

FIG. 9 demonstrates the increased life-span provided by the capability of disabling underperforming battery modules. More specifically, a first curve 910 depicts the capacity of the prototype as a function of the number charge-discharge cycles undergone thereby. Whenever a battery module started underperforming, that battery module was disabled. “Weaker” battery modules were thus temporarily disabled as they neared depletion (when discharging) and then enabled again when charged. Similarly, “Weaker” battery modules were temporarily disabled when nearing saturation in order to avoid unnecessarily exerting the other battery modules, which had yet to reach full capacity.

A second curve 920 depicts capacity as a function of the number charge-discharge cycles underwent, when the battery modules were not individually addressable, thereby mimicking performance of prior-art battery packs, wherein the cells, or at least the battery modules, are not individually addressable.

Additional Switch Systems

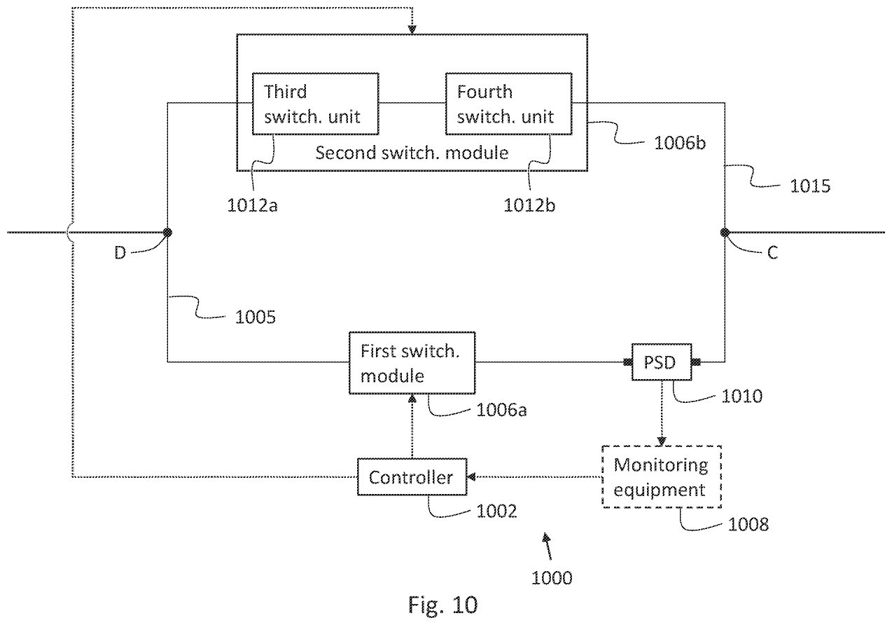

According to an aspect of some embodiments, there is provided a switch system (not shown) for one or more rechargeable PSDs. FIG. 10 is a combined block-circuit diagram of such a switch system, a switch system 1000, according to some embodiments. Switch system 1000 is similar to switch system 100 but differs therefrom, as described below. More specifically, switch system 1000 includes a controller 1002 and a pair of switching modules 1006 including a first switching module 1006a and a second switching module 1006b. Each of switching modules 1006 is functionally associated with controller 1002.

Switch system 1000 is set up with respect to a PSD 1010 (which may be similar to PSD 110)—that switch system 1000 is configured to allow controllably enabling and bypassing (i.e. circumventing)—in essentially the same way as switch system 100 is set up with respect to PSD 110 in FIG. 1A. That is, first switching module 1006a is electrically-coupled to PSD 1010 in series along a first line 1005 extending between a first junction C and a second junction D. PSD 1010 is positioned on first line 1005 such that a positive polarity of PSD 1010 points from first junction C to second junction D. Second switching module 1006b is positioned along a second line 1015 extending from first junction C to the second junction D, and is thus electrically-coupled to PSD 1010 (and first switching module 1006a) in parallel.

Second switching module 1006b is similar to second switching module 106b of switch system 100, and may be switched between the four module states S₀, S₁, S₂, and S₃ defined above. In contrast, first switching module 1006a differs from first switching module 106a of switch system 100 in that it cannot be switched between all of the four module states S₀, S₁, S₂, and S₃. More specifically, according to some embodiments, first switching module 1006a may be switched between the module states S₃ and S₀ (also, in the context of the present aspect, referred to as Uₒₙ and U_{off}, respectively). Thus, first switching module 1006a is switchable between a module state (i.e. Uₒₙ), wherein current is capable of flowing therethrough in both directions (i.e. from first junction C to second junction D and vice-versa (one at a time)), and a module state (i.e. U_{off}), wherein current flow therethrough is blocked (in both directions).

Switch system 1010 is configured such that (joint) states (Uₒₙ, S₂) and (Uₒₙ, S₃) of switching modules 1006 are precluded (i.e. inaccessible at the level of software and/or hardware). The first entry in each pair of brackets denotes the module state of first switching module 1006a and the second entry in each pair of brackets denotes the module state of second switching module 1006b. Thus, as compared to switch system 100, which may in principle be switched between twelve joint states, the number of joint states is halved (i.e. equals six).

Crucially, the preclusion of the states (Uₒₙ, S₂) and (Uₒₙ, S₃) prevents the possibility of short-circuit by discharge of the PSD onto itself, in essentially the same way as described above with respect to switch system 100.

Similarly to first switching module 106a of switch system 100, when first switching module 1006a is in the state U_{off}—that is, when PSD 1010 is bypassed—PSD 1010 may safely be removed.

According to some embodiments, first switching module 1006a may be an on-off switch, such as, for example, a contact switch, a relay, or a diodeless transistor (i.e. a transistor that does not include a body diode).

According to some embodiments, second switching module 1006b may be a specific embodiment of second switching module 106b of switch system 100. According to some embodiments, and as depicted in FIG. 10, second switching module 1006b may be a specific embodiment of second switching module 206b of switch system 200. In such embodiments, second switching module 1006b may include a first switching unit 1012a and a second switching unit 1012b, which are, respectively, specific embodiments of third switching unit 212c and fourth switching unit 212d of second switching module 206b of switch system 200. According to some embodiments, switching unit 1012a and 1012b may be specific embodiments of switching units 312c and 312d (of FIG. 3A), respectively, switching units 412c and 412d (of FIG. 4A), respectively, or switching units 412c′ and 412d′ (of FIG. 4B), respectively.

According to some embodiments, switch system 1000 may further include monitoring equipment 1008, which is functionally associated with controller 1002 and configured to monitor the PSD, essentially as described above in the description of switch system 100. The monitoring equipment may be similar to monitoring equipment 108 of switch system 100.

According to some embodiments, the switch system includes PSD 1010.

To bypass PSD 1010 starting at an initial circuit state wherein PSD 1010 is discharging and a current flows exclusively through first line 1005 (from first junction C to second junction D)—that is, starting at the joint state (Uₒₙ, S₀) of switching modules 1006—controller 1002 may be configured to switch switching modules 1006 through the sequence of joint states: (Uₒₙ, S₀)→(Uₒₙ, S₁)→(U_{off}, S₁)→(U_{off}, S₃). In the intermediate joint state (Uₒₙ, S₁) the current is split between first line 1005 and second line 1015, thereby preventing, or at least minimizing, any dip in the current.

To enable PSD 1010 so as to reach a circuit state, wherein PSD 1010 is discharging, from an initial circuit state, wherein current flows from first junction C to second junction D through second line 1005 (i.e. so that the joint state of switching modules 1006 is (U_{off}, S₃)), the order of switching operations described above may be inverted.

To bypass PSD 1010 starting at an initial circuit state wherein PSD 1010 is being charged and a current flows exclusively through first line 1005 (from second junction D to first junction C)—that is, starting at the joint state (Uₒₙ, S₀) of switching modules 1006—controller 1002 may be configured to switch switching modules 1006 through the sequence of joint states: (Uₒₙ, S₀)→(Uₒₙ, S₁)→(U_{off}, S₃). Alternatively, controller 1002 may be configured to switch switching modules 1006 directly from (Uₒₙ, S₀) to (U_{off}, S₃). In particular, controller 1002 is configured to synchronize the switching of first switching module 1006a (i.e. from Uₒₙ to U_{off}) and the switching of second switching module 1006b to the module state S₃, so that the joint state is (Uₒₙ, S₃) is not realized at any point during the transition. The synchronization may be effected by software and/or hardware. More specifically, the switching time(s) of first switching module 1006a (i.e. the time(s) it takes to switch from U_{off} to Uₒₙ and vice-versa) and the switching time(s) of second switching module 1006b (i.e. the time(s) it takes to switch from S₀ to S₃ and vice-versa) may be about equal (as well as synchronized), thereby preventing possibility short-circuit during the switching.

To enable PSD 1010 so as to reach a circuit state, wherein PSD 1010 is charging, from an initial circuit state, wherein current flows from second junction D to first junction C through second line 1015 (i.e. so that the joint state of switching modules 1006 is (U_{off}, S₃)), the order of switching operations described above may be inverted.

Thus, when bypassing PSD 1010 starting from an initial circuit state wherein PSD 1010 is charging or enabling PSD 1010 to a state wherein PSD 1010 is charging, the current is not partitioned between first line 1005 and second line 1015. The presently described switch system (i.e. switch system 1000) may thus be utilized in setups wherein such partitioning of the current is not required.

It is noted, however, that—as already mentioned—switch system 100 is also capable of such a direct transition.

As used herein, the nouns “energy” and “power” may be used interchangeably. Thus, for example, the terms “energy storage” and “power storage” are interchangeable. In particular, the terms “energy storage device” and “power storage device” are interchangeable. Similarly, the terms “energy source” and “power source” are interchangeable.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1-42. (canceled)

43. A switch system for one or more rechargeable power storage devices (PSDs), the switch system comprising a controller and pair of switching modules comprising a first switching module and a second switching module, which are functionally associated with the controller;
wherein (i) the first switching module is serially-connected to the PSD and is positioned together therewith on a first line extending from a first junction A to a second junction B with a positive polarity of the PSD pointing in the A-to-B direction, and (ii) the second switching module is connected in parallel to the PSD and the first switching module and is positioned on a second line extending from A to B;
wherein each switching module is switchable by the controller between four module states:
a module state S₁, wherein current flow therethrough from B to A is blocked;
a module state S₂, wherein current flow therethrough from A to B is blocked;
a module state S₃, wherein current is capable of flowing therethrough both from A to B and B to A; and
a module state S₀, wherein current flow therethrough in both directions is blocked; and
wherein the switch system is configured to preclude joint states (S₁, S₂), (S₁, S₃), (S₃, S₂), and (S₃, S₃), with a first and a second entry in each pair of brackets denoting module states of the first and second switching modules, respectively, thereby preventing a possibility of short-circuit via discharge of the PSD onto itself.

44. The switch system of claim 43, wherein the controller is further configured to:
disable the PSD, when discharging, by diverting current from the first line to the second line via switching of the switching modules from (S₃, S₀) to (S₀, S₃), via (S₁, S₁) and/or (S₃, S₁); and
enable the PSD to discharge, by diverting current from the second line to the first line via switching of the switching modules from (S₀, S₃) to (S₃, S₀), via (S₁, S₁) and/or (S₃, S₁).

45. The switch system of claim 43, wherein the controller is further configured to:
disable the PSD, when charging, by diverting current from the first line to the second line via switching of the switching modules from (S₃, S₀) to (S₀, S₃), via (S₂, S₂) and/or (S₂, S₃); and
enable the PSD to charge, by diverting current from the second line to the first line via switching of the switching modules from (S₀, S₃) to (S₃, S₀), via (S₂, S₂) and/or (S₂, S₃).

46. The switch system of claim 43, wherein the first switching module comprises two serially-connected switching units: a first switching unit and a second switching unit;
wherein the second switching module comprises two serially-connected switching units: a third switching unit and a fourth switching unit;
wherein each of the first and third switching units is switchable between a two-way conduction state M, and a first one-way conduction state M_{AB}, wherein current flow therethrough from B to A is blocked; and
wherein each of the second and fourth switching units is switchable between a two-way conduction state M, and a second one-way conduction state M_{BA}, wherein current flow therethrough from A to B is blocked.

47. The method of claim 46, wherein when the first switching module is in the module state: (a) S₀, the first and second switching units are in the states M_{AB} and M_{BA}, respectively; (b) S₁, the first and second switching units are in the states M_{AB} and M, respectively; (c) S₂, the first and second switching units are in the states M and M_{BA}, respectively; and (d) S₃, the first and second switching units are each in the state M; and
wherein when the second switching module is in the module state: (a) S₀, the third and fourth switching units are in the states M_{AB} and M_{BA}, respectively; (b) S₁, the third and fourth switching units are in the states M_{AB} and M, respectively; (c) S₂, the third and fourth switching units are in the states M and M_{BA}, respectively; and (d) S₃, the third and fourth switching units are each in the state M.

48. The switch system of claim 46, wherein, in one or both of the switching modules, each of the switching units comprises (i) a respective transistor and a respective diode, or (ii) a respective transistor comprising a body diode;
wherein each of the transistors comprises a respective input terminal, output terminal, and control terminal;
wherein the control terminal is communicatively associated with the controller; and
wherein, if (i), the diode is mounted between the input terminal and the output terminal, so as to be connected in parallel to the transistor, and, if (ii), the body diode is mounted between the input terminal and the output terminal.

49. The switch system of claim 48, wherein:
a. a first terminal of the first switching unit is connected to a first terminal of the second switching unit;
the first terminal and a second terminal of the first switching unit are the input and output terminals, respectively, or the output and input terminals, respectively, of the first switching unit; and
the first terminal and a second terminal of the second switching unit are the input and output terminals, respectively, or the output and input terminals, respectively, of the second switching unit; and/or
b. a first terminal of the third switching unit is connected to a first terminal of the fourth switching unit;
the first terminal and a second terminal of the third switching unit are the input and output terminals, respectively, or the output and input terminals, respectively, of the third switching unit; and
the first terminal and a second terminal of the fourth switching unit are the input and output terminals, respectively, or the output and input terminals, respectively, of the fourth switching unit; and
wherein the respective diode of each of the switching units is configured to block flow of current through the diode from the first terminal to the second terminal of the switching unit.

50. The switch system of claim 48, wherein the transistor is a field-effect transistor (FET), and wherein the input terminal corresponds to the source of the FET, the output terminal corresponds to the drain of the FET, and the control terminal corresponds to the gate of the FET.

51. The switch system of claim 48, wherein the transistor is a bipolar transistor, and wherein the input terminal corresponds to the collector of the bipolar transistor, the output terminal corresponds to the emitter of the bipolar transistor, and the control terminal corresponds to the base of the bipolar transistor, wherein the FET is a metal-oxide semiconductor FET (MOSFET).

52. The switch system of claim 43, wherein, in switching from a start state to an end state, a duration spent in an intermediate state, switched to between the start state and the end state and such that current is capable of flowing through both the first line and the second line, is at least about a time it takes for the switching modules to switch between module states, wherein:
in diverting current from the first line to the second line, when the PSD is charging or discharging, the start state is (S₃, S₀) and the end state is (S₀, S₃); and
in diverting current from the second line to the first line, so as to charge or discharge the PSD, the start state is (S₀, S₃) and the end state is (S₃, S₀).

53. The switch system of claim 4, further comprising a first interlock and a second interlock, which are functionally associated with the controller;
wherein the first switching unit is coupled to the fourth switching unit via the first interlock, which is configured to prevent any module state wherein the first switching unit is in any of the states M and M_{AB} and the fourth switching unit is simultaneously in any of the states M and M_{BA}; and
wherein the second switching unit is coupled to the third switching unit via the second interlock, which is configured to prevent any module state wherein the second switching unit is in any of the states M and M_{BA} and the third switching unit is simultaneously in any of the states M and M_{AB}.

54. The switch system of claim 46, further comprising a first interlock and a second interlock, which are functionally associated with the controller;
wherein the first interlock is coupled to the controller inputs of the transistor of the first switching unit and the transistor of the fourth switching unit, so as to prevent any module state wherein the first switching unit is in any of the states M and M_{AB} and the fourth switching unit is simultaneously in any of the states M and M_{BA}; and
wherein the second interlock is coupled to the controller inputs of the transistor of the second switching unit and the transistor of the third switching unit, so as to prevent any module state wherein the second switching unit is in any of the states M and M_{BA} and the first switching unit is simultaneously in any of the states M and M_{AB}.

55. The switch system of claim 43, wherein the PSD comprises a rechargeable battery pack, the battery pack comprises a plurality of batteries connected, or connectable, to one another in series, parallel, and/or a combination thereof.

56. The switch system of claim 55, wherein the battery pack is an electric vehicle (EV) battery pack.

57. The switch system of claim 56, wherein the EV battery pack is a second-life EV battery pack.

58. The switch system of claim 43, further comprising monitoring equipment, which comprises one or more of an ammeter, a voltmeter, an ohmmeter, and/or capacitance meter;
wherein the monitoring equipment is configured to monitor a state-of-charge (SoC) and/or remaining capacity, of the PSD, and to send to the monitored SoC and/or the monitored remaining capacity, to the controller;
wherein the controller is configured to, when the PSD is discharging, instruct the switching modules to disable the PSD when the PSD becomes depleted or sufficiently near depleted; and
wherein the controller is configured to, when the PSD is charging, instruct the switching modules to disable the PSD when the PSD becomes saturated or sufficiently near saturated.

59. The switch system of claim 58, wherein the monitoring equipment further comprises one or more of a thermometer, configured to measure a temperature of the PSD, and/or a pressure meter, configured to measure a pressure within the PSD;
wherein the monitoring equipment is configured to send the measured temperature and/or the measured pressure to the controller; and
wherein the controller is configured to instruct the switching modules to disable the PSD when the measured temperature exceeds a threshold temperature and/or when the measured pressure exceeds a threshold pressure.

60. The switch system of claim 43, comprising a plurality of the pairs of switching modules, each of which is configured to allow enabling and disabling a respective PSD.

61. A method for switching current between a first line, having mounted thereon a power storage device (PSD), a and a second line, the two lines extending from a first junction to a second junction, the method comprising, starting at an initial circuit state, wherein current is capable of being conducted through a first of the two lines in both directions, and is presently conducted in a first direction, and current flow through a second of the two lines is blocked, performing operations of:
precluding current flow through the first line in opposite to the first direction;
enabling current flow through the second line in the first direction, so that the current is divided between the two lines, flowing in the first direction through each of the two lines; and
blocking current flow through the first line and enabling possibility of current flow through the second line in both directions, so that the current flows only through the second line and in the first direction.

62. A power management system (PMS) for controlling and regulating charging and discharging of an array including rechargeable PSDs, the PMS comprising the switch system of claim 1, and monitoring equipment configured to monitor at least SoCs and/or remaining capacities of the PSDs in the array, wherein the controller is configured to switch each of the switching modules between the respective module states thereof based at least on the monitored SoCs and/or remaining capacities of the PSDs in the array.
